(19) United States
(12) Patent Application Publication
(10) Pub. No.: US 2003/0210244 A1
(43) Pub. Date: Nov. 13, 2003

(54) Information processing apparatus and method

(75) Inventors: Yoshikazu Sasago, Shizuoka (JP); Ryozo Yanagisawa, Shizuoka (JP); Hiroshi Takarada, Shizuoka (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/430,213

(22) Filed: May 7, 2003

(30) Foreign Application Priority Data
May 10, 2002 (JP) 2002-136192
May 10, 2002 (JP) 2002-136193

(51) Int. Cl. G06T 15/00

(52) U.S. Cl. 345/419; 700/98

(57) ABSTRACT

To add attributes to data created by a CAD equipment, a sequence of steps are performed which involves: executing a CAD program; generating a geometric model and displaying it as an image on a display screen; generating a projected figure of the geometric model projected in a desired direction and putting the projected figure in the same 3D space in which the geometric model is placed; adding attribute information including dimensional tolerances to the geometric model; performing a display control, such as displaying/undisplaying and coloring of the attribute information including dimensional tolerances; relating a display method to the projected figure and to the attribute information associated with the projected figure; storing the attribute information in an external storage device; and storing a CAD attribute model of the geometric model attached with the attribute information in the external storage device.

This application claims priority from Japanese Patent Application Nos. 2002-136192 filed May 10, 2002, and 2002-136193 filed May 10, 2002, which are incorporated hereinto by reference.

### BACKGROUND OF THE INVENTION

1. Field of the Invention

The present invention relates to an information processing apparatus and method and more particularly to an information processing apparatus, method and program using a 3-dimensional model (3D geometry) generated by a 3D CAD (computer-aided design).

2. Description of the Related Art

Objects with three-dimensional geometries that make up a product or component (hereafter referred to simply as parts) have conventionally been designed using CAD equipment (particularly 3D-CAD equipment).

Based on a design created by the CAD equipment, molds for manufacturing parts are made. In using design information prepared by the CAD equipment, a 3D model (3D geometry) is given attribute information such as dimensions, dimensional tolerances, geometrical tolerances, annotations and symbols.

Attribute information is entered into a 3D model by specifying and selecting a desired surface, edge, center line or vertex of the 3D model. For example, a 3D model 41 shown in FIG. 1 (a front view, top view and side view of this 3D model are shown at reference numbers 2601-2603, respectively, in FIG. 2) are given attribute information as shown in FIG. 3.

Here, the attribute information includes:

dimensions, such as distances (lengths, widths and thicknesses), angles, hole diameters, radii and chamfers, and dimensional tolerances accompanying these dimensions;

geometrical tolerances and dimensional tolerances added to surfaces and edges without giving any dimensions;

annotations or information to be communicated or specified in processing or manufacturing parts, units and products; and

symbols and other predetermined conventions, such as surface roughness.

Methods of adding attribute information to a 3D model may be classified largely into two kinds.

(1) When adding dimensions, dimensional tolerances, geometrical tolerances, annotations and symbols:

Adding dimensions and dimensional tolerances requires dimension lines and extension lines; and adding geometrical tolerances, annotations and symbols requires leader lines.

(2) When adding dimensional tolerances, geometrical tolerances, annotations and symbols without giving dimensions:

Dimension lines and extension lines are not necessary but leader lines are required for entering dimensional tolerances, geometrical tolerances, annotations and symbols.

Mold making is performed using a 3D model. It has been necessary to make measurements and inspections to check whether a manufactured mold and molded products conform to the design.

In adding the attribute information, when auxiliary lines, symbols or text information is necessary, it is common practice to prepare from the geometric data of the 3D model a two-dimensional drawing that represents a two-dimensional geometry of the model and to indicate these information on the two-dimensional drawing. In JIS B 0001 mechanical drawing, such information may, for example, include the following:

A table of symbols representing holes in the coordinate dimensioning and positions of holes

Values indicated separately when letter symbols are used instead of dimensional values

Extension lines used to add dimensions at intersections between extended visible outlines

Thin solid lines indicating planes that are shown for reference to represent an adjoining part or shapes and positions of tools and jigs

A range of specially machined portion illustrating tapers and gradients and necessary items defining a special machining

Letters and magnifications used in auxiliary views and partially enlarged views

Further, it has been necessary to make measurements and inspections to see if manufactured parts or moulds, or molded products from the molds conform to the design.

The conventional methods described above for adding attribute information to a 3D model have the following problems.

In the case of (1), the dimensions and dimensional tolerances and the dimension lines and extension lines for entering these complicate the drawing making the geometry and attribute information of the 3D model difficult to read.

If the model has a relatively simple shape and the number of attribute information is around several tens, as shown in FIG. 3, the drawing may be able to be read without much trouble. However, if the model has a more complex or larger shape, several hundreds to several thousands of attribute information will be added to the 3D model as required. In that case, “attribute information may overlap each other,” “attribute information and the dimension lines, extension lines or leader lines may overlap,” and “the positions that the dimension lines, extension lines or leader lines refer to are not clearly visible,” making the attribute information difficult to read (even in FIG. 3, stepped geometry at a corner portion is somewhat difficult to see).

In such a case, an operator himself who are entering attribute information may not be able to clearly see the input information and to check what was entered. As a result, the entering of attribute information itself is rendered difficult.

As a result, associated attribute information are extremely difficult to read. Another problem is that a space occupied by the attribute information becomes large compared with the 3D model, making it impossible for the 3D model and the attribute information to be displayed simultaneously on the display screen of a limited size.

Further, the locations that attribute information to be specified in a cross-sectional view (e.g., depth of a counterboring: 12±0.1 in FIG. 3) refers to cannot be seen in the 3D model 41, making the drawing difficult to read.

In the case of (2), although the dimension lines and extension lines are not required, the leader lines are used, so that, as with the case (1), the leader lines make the drawing complex and the 3D model geometry and attribute information difficult to see. In the case of a 3D model of complex or large shape, since several hundred to several thousands of attribute information is added to the 3D model, the reading of the attribute information is extremely difficult.

When checks are made of a fabricated mold and of molded products from the mold, their dimensions need to be measured. To take measurements of various dimensions, the 3D model geometry must be subjected to a measurement process.

In this case, a location that forms a reference or base for planes or edges to be measured must be specified and selected. The reading of dimensions of a plurality of portions takes a large number of operations and a great deal of time. A possibility of misreading from erroneous operation cannot be excluded. Further, reading the dimensions of all portions entails an excessively large time and labor.

The so-called design information including a 3D model and attribute information is information that is needed to process and manufacture parts and units and must be communicated clearly and efficiently without errors from an operator who enters these information (i.e., designer) to an operator who sees them (engineer in processing, manufacturing and inspection processes). The above conventional techniques, however, do not meet these requirements at all and thus cannot effectively be put to industrial use.

Further, during the process of adding attribute information to a 3D model, if auxiliary lines, symbols or text information is required and is shown on a two-dimensional drawing generated from the 3D model data, it is necessary to prepare the two-dimensional drawing as well as the 3D model and attribute information in order to enter or view all the design information. This extremely degrades an efficiency in both entering and viewing data.

Further, the 3D model and attribute information and the two-dimensional drawing are required to be coordinated with each other as design information. That is, a geometry of the 3D model and a geometry of the two-dimensional drawing must be the same. Further, to avoid misunderstanding or confusion, the attribute information and the information used in the two-dimensional drawing must not overlap each other. They must remain coordinated even after the geometry has been modified. This entails a great deal of labor for management and operation.

### SUMMARY OF THE INVENTION

The present invention has been accomplished to overcome these problems and to provide an information processing apparatus and method which allows attributes to be entered and added to data prepared by a CAD equipment with good operability, i.e., allows attributes to be entered and viewed with a high level of ease.

Another object of this invention is to provide an information processing apparatus and method which allows added attributes to be seen and identified easily and design information to be communicated reliably.

Still another object of this invention is to provide an information processing apparatus and method which can effectively utilize data prepared by a CAD equipment and efficiently perform a part manufacture by using the data.

Yet another object of this invention is to provide an information processing apparatus and method which can effectively utilize data prepared by a CAD equipment and efficiently perform a part manufacture by using the data without using a two-dimensional drawing.

A further object of this invention is to provide an information processing apparatus and method which can perform an inspection step efficiently by using data prepared by a CAD equipment.

To achieve these objectives, the present invention provides an information processing apparatus comprising: a projection means for projecting a 3D (three-dimensional) model in an arbitrary direction of a 3D space; an attribute input means for entering attribute information for the 3D model; and an attribute placement means for placing the attribute information on a projection plane of the 3D model.

Further, to achieve the above objectives, the present invention provides an information processing method comprising: a projection step of projecting a 3D model in an arbitrary direction of a 3D space; an attribute input step of entering attribute information for the 3D model; and an attribute placement step of placing the attribute information on a projection plane of the 3D model.

With the arrangement described above, it is possible to enter and associate the attribute information with the 3D model and the projected figure. This enables the attribute information to be entered very easily regardless of the number of pieces of attribute information. This arrangement also makes the attribute information easily recognizable and allows it to be communicated reliably.

Further, to achieve the above objectives, the present invention provides an information processing apparatus comprising: an attribute input means for entering attribute information for a 3D model; an attribute placement plane setting means for setting a virtual plane with which the attribute information is associated; a projection means for projecting the 3D model onto the virtual plane; and a storage means for storing the attribute information by associating the attribute information with the virtual plane.

Further, to achieve the above objectives, the present invention provides an information processing method comprising: an attribute input step of entering attribute information for a 3D model; an attribute placement plane setting step of setting a virtual plane with which the attribute information is associated; a projection step of projecting the 3D model onto the virtual plane; and a storage step of storing the attribute information by associating the attribute information with the virtual plane.

With the above arrangement, the attribute information can be entered and placed on a desired virtual plane. By generating a projected figure of the 3D model on the virtual plane, the attribute information can be entered very easily regardless of the number of pieces of the attribute information. This arrangement also makes the attribute information intelligible and allows it to be communicated reliably.

Further, the information processing apparatus of this invention further comprises a 2D (two-dimensional) figure drawing and editing means for drawing and editing a 2D figure on the virtual plane.

Further, the information processing apparatus of this invention further comprises a text generation and editing means for generating and editing text information on the virtual plane.

Further, the information processing method of this invention further comprises a 2D figure drawing step of drawing a 2D figure on the virtual plane.

Further, the information processing method of this invention further comprises a text generation and editing step of generating and editing text information on the virtual plane.

With the above arrangement of this invention, it is possible to efficiently communicate design information using a 3D model, attribute information, and a 2D figure and text information on the virtual plane, without generating a two-dimensional drawing, which represents a shape two-dimensionally, from figure data of a 3D model.

As described above, this invention projects a 3D model in a desired direction of a 3D space, enters attribute information on the 3D model and places the attribute information on a projection plane of the 3D model.

This allows the attribute information being entered to be associated with the projected figure of the 3D model, which in turn allows the attribute information to be entered very easily regardless of the number of pieces of the attribute information. This arrangement also makes the attribute information intelligible and allows it to be communicated reliably.

With this invention, it is possible to efficiently perform a part manufacture that utilizes data created by a CAD equipment.

Further, this invention enters attribute information on a 3D model, sets a virtual plane with which the attribute information is to be associated, projects the 3D model onto the virtual plane, and associates the attribute information with the virtual plane before storing it.

As a result, not only can the attribute information be entered and placed on a desired virtual plane but, by generating a projected figure of the 3D model on the virtual plane, the input of the attribute information can also be done with great ease regardless of the number of pieces of the attribute information. This arrangement also makes the attribute information intelligible and allows it to be communicated reliably.

Further, this invention draws and edits a 2D figure on the virtual plane and generates and edits text information on the virtual plane. This makes it possible to efficiently communicate design information using a 3D model, attribute information, and a 2D figure and text information on the virtual plane, without generating a two-dimensional drawing, which represents a shape two-dimensionally, from figure data of a 3D model.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is an example view showing a conventional 3D model;

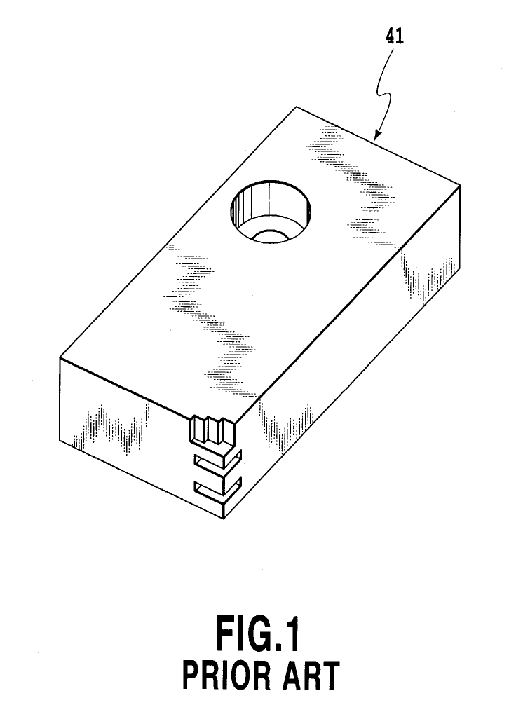

FIG. 2 is two-dimensional standard three views of the conventional 3D model of FIG. 1;

FIG. 3 is a conventional 3D model of FIG. 1 attached with attribute information;

FIG. 4 is a diagram showing an overall flow of production of a mold used to mold a part in Embodiment 1 and 2 of this invention;

FIG. 5 is a block diagram showing a CAD equipment in Embodiment 1 and 2 of this invention;

FIG. 6 is a flow chart showing a sequence of operations performed by the CAD equipment of FIG. 5 in Embodiment 1 of this invention;

FIGS. 7A and 7B are example views of geometric models, FIG. 7A representing an example of a solid model and FIG. 7B representing an example of a Shell model in Embodiment 1 and 2 of this invention;

FIG. 8 is a conceptual diagram showing a relation among parts making up a geometric model in Embodiment 1 and 2 of this invention;

FIG. 9 is a conceptual diagram showing how Face information is stored and managed in an internal storage device in Embodiment 1 and 2 of this invention;

FIG. 10 is a diagram showing a 3D model and projected figures of the model in Embodiment 1 of this invention;

FIG. 11 is a diagram showing a 3D model and a projected figure of a cross section of the model in Embodiment 1 of this invention;

FIG. 12 is a diagram showing a 3D model, a projected figure of the model and attribute information in Embodiment 1 of this invention;

FIG. 13 is a diagram showing projected figures of a 3D model and attribute information in Embodiment 1 and 2 of this invention;

FIG. 14 is a diagram showing a 3D model and attribute information in Embodiment 1 of this invention;

FIG. 15 is a flow chart showing a sequence of operations performed to add attribute information to a 3D model in Embodiment 1 of this invention;

FIG. 16 is a flow chart showing a sequence of operations performed to add attribute information to a 3D model in Embodiment 1 of this invention;

FIG. 17 is a flow chart showing a sequence of operations performed to display attribute information on a 3D model in Embodiment 1 of this invention;

FIG. 18 is a flow chart showing a sequence of operations performed to add attribute information to a 3D model in Embodiment 1 of this invention;

FIG. 19 is a flow chart showing a sequence of operations performed to display a 3D model attached with attribute information in Embodiment 1 of this invention;

FIG. 20 is a diagram showing a 3D model, a projected figure of a cross section of the model, and attribute information in Embodiment 1 of this invention;

FIG. 21 is a diagram showing how a plurality of projected figures are set for the 3D model;

FIG. 22 is a diagram showing a 3D model, a projected figure of the model and attribute information in Embodiment 1 and 2 of this invention;

FIGS. 23A to 23D illustrate examples of a 3D model in Embodiment 1 and 2 of this invention, FIG. 23A representing a perspective view of the 3D model, FIG. 23B representing a top view of the 3D model, FIG. 23C representing a perspective view of the 3D model attached with attribute information as is, and FIG. 23D representing a perspective view of the 3D model with an improved arrangement of attribute information;

FIG. 24 is an explanatory diagram showing how attribute information is described in Embodiment 1 and 2 of this invention;

FIGS. 25A to 25C represent a part of a 3D model in Embodiment 1 and 2 of this invention, FIG. 25A representing the 3D model, FIG. 25B showing a stepped geometry and attribute information in an easily readable manner, and FIG. 25C showing a projected figure with a magnification by 5 and with a character height of 3 mm;

FIG. 26 is a flow chart for displaying a 3D model and attribute information from attribute information in Embodiment 1 and 2 of this invention;

FIG. 27 is a flow chart for displaying a 3D model and attribute information from geometry information in Embodiment 1 and 2 of this invention;

FIG. 28 is a flow chart showing a sequence of operations performed by the CAD equipment of FIG. 5 in Embodiment 2 of this invention;

FIG. 29 is a diagram showing a 3D model, an attribute placement plane and projected figureprojected figures in Embodiment 2 of this invention;

FIG. 30 is a diagram showing a 3D model, and an attribute placement plane and a projected figure of a cross section of the model in Embodiment 2 of this invention;

FIG. 31 is a diagram showing a 3D model, an attribute placement plane, a projected figure and attribute information in Embodiment 2 of this invention;

FIG. 32 is a diagram showing a 3D model, an attribute placement plane, and attribute information in Embodiment 2 of this invention;

FIG. 33 is a flow chart showing a sequence of operations performed to add attribute information to a 3D model in Embodiment 2 of this invention;

FIG. 34 is a flow chart showing a sequence of operations performed to display attribute information on a 3D model in Embodiment 2 of this invention;

FIG. 35 is a flow chart showing a sequence of operations performed to add attribute information to a 3D model in Embodiment 2 of this invention;

FIG. 36 is a flow chart showing a sequence of operations performed to add attribute information to a 3D model in Embodiment 2 of this invention;

FIG. 37 is a flow chart showing a sequence of operations performed to display a 3D model attached with attribute information in Embodiment 2 of this invention;

FIG. 38 is a diagram showing a 3D model, an attribute placement plane and a projected figure of a cross section of the model, and attribute information in Embodiment 2 of this invention; and

FIG. 39 is a diagram showing how a plurality of attribute placement planes and projected figures are set for a 3D model in Embodiment 2 of this invention.

### DETAILED DESCRIPTION OF PREFERRED EMBODIMENTS

Now, embodiments of the present invention will be described in detail by referring to the accompanying drawings. In each of the drawings parts with identical functions are assigned like reference numbers.

Embodiment 1

Embodiment 1 embodying the present invention will be detailed by referring to the drawings.

<<Overall Flow in Manufacturing a Mold>>

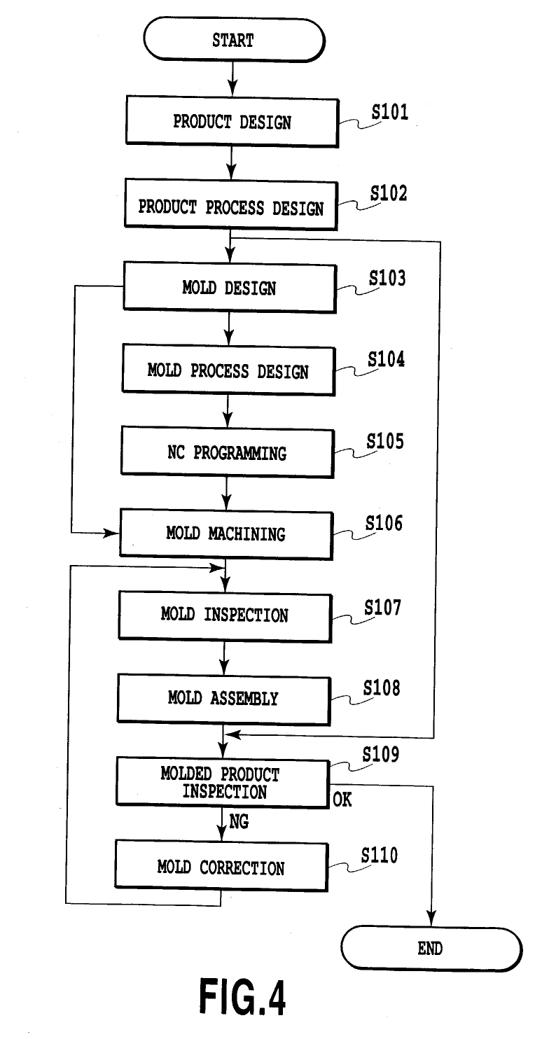

FIG. 4 shows an overall flow in a process of manufacturing a mold used for molding a part according to Embodiment 1 of this invention.

In FIG. 4, step S101 designs a product, preparing drawings of individual parts. The parts drawings include information required for the manufacture of the parts and information on restrictions. In Embodiment 1, the drawings of parts are generated by a 3D-CAD. The drawings prepared by the 3D-CAD (3D drawings) include geometries and attribute information such as dimensional tolerances and texts (annotations). The attribute information can be related to geometries (surfaces, edges and points), and the dimensional tolerances are used for specifying inspections on molded parts and for specifying a precision of the mold.

In step S102 a producibility such as product assembling and moldability is examined and a process drawing is prepared for each part. The process drawings for parts include detailed inspection specifications in addition to information required for parts manufacture. The process drawings are generated by a 2D-CAD or 3D-CAD.

Examples of detailed inspection specifications include:

numbering of items to be measured (dimensions or dimensional tolerances), and

Specification of measuring points and method of measurement for the items to be measured.

Information on detailed inspection specifications can be related to dimensional tolerances on CAD.

In step S103, based on the process drawings (drawings and mold specifications) prepared in step S102, a mold is designed and mold drawings are prepared. The mold drawings include information necessary for the manufacture of the mold and limiting conditions. The mold drawings are generated by a 2D-CAD or 3D-CAD, and the mold drawings (3D drawings) include geometries and attribute information such as dimensional tolerances.

In step S104, based on the mold drawings prepared by step S103, a process of manufacturing the mold is examined to generate mold process drawings. The mold machining process comprises a numerically controlled (NC) machining and a general machining. For a process that performs the NC machining (automatic machining based on numerical control), a generation of an NC program is specified. For a process that performs the general machining (manual machining), the general machining is specified.

In step S105, an NC program is generated based on the mold drawings.

In step S106, mold parts are manufactured as by machine tools.

In step S107, the manufactured mold parts are inspected according to the information prepared in step S103.

In step S108, the mold parts are assembled for molding.

In step S109, molded products are inspected according to the information prepared in steps S101 and S102. If the molded products pass the inspection, the mold manufacturing process is completed.

In step S110, according to the result of inspections in step S109, the mold is corrected at locations corresponding to those portions of the molded product which do not meet precision requirements.

<<Design of Product>>

Next, a process of designing a product and preparing drawings of individual parts will be explained. The parts drawings are generated by a 3D-CAD equipment.

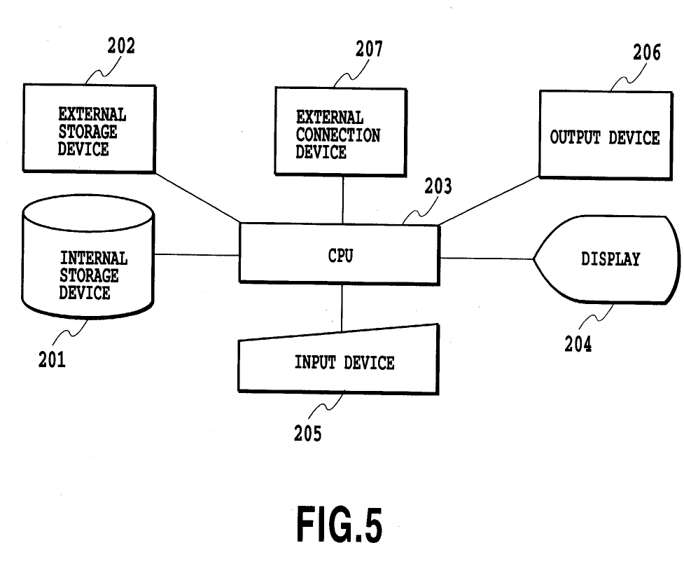

Here, a designing of parts by using the 3D-CAD equipment, or information processing apparatus, of FIG. 5 will be explained.

FIG. 5 is a block diagram of the CAD equipment. In FIG. 5, denoted 201 is an internal storage device and 202 an external storage device. They may be a semiconductor storage device, such as RAM (random access memory), and a magnetic storage device, respectively, to store CAD data and CAD programs.

Designated 203 is a CPU (central processing unit) which executes processing by following instructions from the CAD programs.

Denoted 204 is a display that displays shapes according to the instructions from the CPU 203.

Denoted 205 is an input device such as mouse and keyboard to give a command to the CAD programs.

Denoted 206 is an output device such as printer to produce a drawing according to instructions from the CPU 203.

Denoted 207 is an external connection device that connects an external device to the CAD equipment to supply data from the CAD equipment to the external device or control the CAD equipment from the external device.

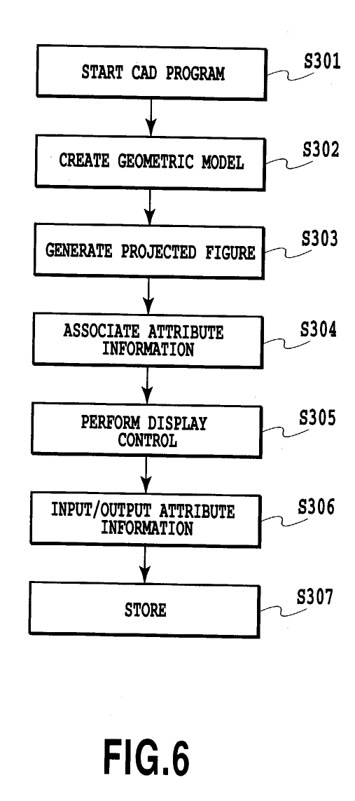

FIG. 6 is a flow chart showing a sequence of operations performed by the CAD equipment of FIG. 5.

First, when an operator instructs the CAD program to start using the input device 205, the CAD program stored in the external storage device 202 is read into the internal storage device 201 and is executed on the CPU 203 (step S301).

The operator interactively gives instructions through the input device 205 to generate a geometric model on the internal storage device 201 which is then shown on the display 204 (step S302). The geometric model will be described later. The operator can also specify a file name through the input device 205 to read the geometric model already generated on the external storage device 202 into the internal storage device 201 so that it can be handled on the CAD program.

Next, the operator creates figures of a geometric model in a 3D space projected in desired directions by using the input device 205. The projected figure include so-called primary six views, such as top view and front view, and a section view to which a cross section is projected. These projected figures are arranged in the same 3D space as the geometric model (step S303). While the projected figures are preferably created by projecting an entire model to projection planes, it is also possible to selectively project surfaces or edges, or any desired part of the model.

Next, the operator using the input device 205 adds dimensional tolerances as attribute information to the geometric model (step S304). The added attribute information can be displayed on the screen as image information such as a label. The added attribute information is associated with one of the projected figures and stored in the internal storage device 201.

In the process of association, the operator may specify through the input device 205 search conditions for the attribute information so that the attribute information may be controlled for display as one group. The grouped attribute information is stored in the internal storage device 201. The operator may specify a group in advance and then proceed to add attribute information to the projected figures. Further, the operator can add or delete attribute information to and from a particular group by using the input device 205.

Next, the operator specifies conditions such as group using the input device 205 and performs a display control including displaying/undisplaying and coloring of the attribute information, such as dimensional tolerances, (step S305). Further, the operator specifies through the input device 205 a method of display including a direction in which the geometric model is displayed, a magnification and a display center, i.e., how the model is viewed. This will be described later. The direction of display is set to match a direction of projection of the projected figure. The direction of display may be set before generating the projected figure. The method of display may be associated with the projected figure or with the attribute information associated with the projected figure. When the method of display is specified, only the associated attribute information and projected figure can be displayed. The method of display is stored in the internal storage device.

The operator can specify the external storage device 202 in which to store the attribute information (step S306). An identifier may be attached to the attribute information before storing the attribute information in the external storage device 202. Using this identifier, the attribute data can be associated with other data.

The attribute information on the external storage device 202 may be read into the internal storage device 201 and information may be added to update the attribute information.

The operator using the input device 205 stores in the external storage device 202 a CAD attribute model which is the geometric model attached with attribute information (step S307).

Here, a geometric model and a CAD attribute model will be explained.

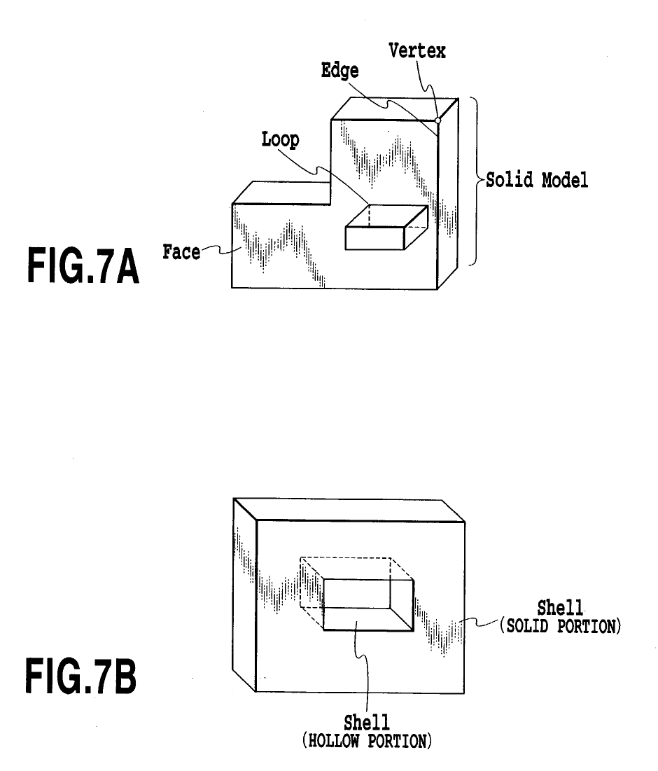

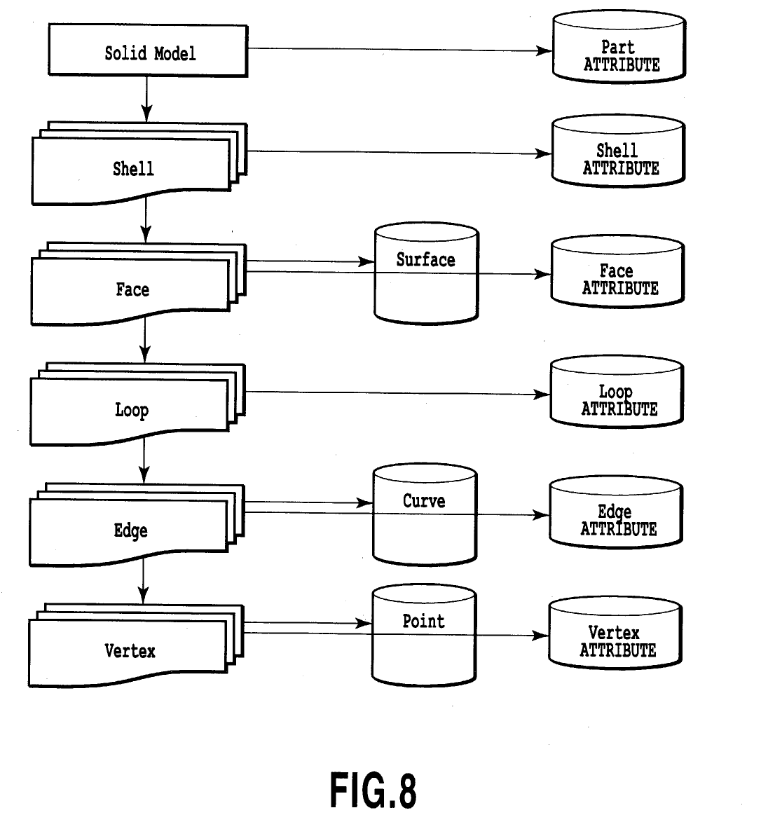

FIGS. 7A and 7B show examples of 3D geometric model and FIG. 8 is a conceptual diagram showing a relationship among parts making up the 3D geometric model.

FIGS. 7A and 7B show solid models as representative examples of 3D geometric models. As shown in the figures, the solid models provide a method of representation that defines a shape of an object or a part in a three-dimensional space on a CAD and has topology information and geometry information. The topology information on a solid model, as shown in FIG. 8, is stored hierarchically in the internal storage device 201 and comprises:

one or more Shells,

one or more Faces for each Shell,

one or more Loops for each Face,

one or more Edges for each Loop, and

two Vertices for each Edge.

The Face is associated with Surface information which represents a shape of the Face, such as a flat surface and a cylindrical surface, and stored and managed in the internal storage device 201. The Edge is associated with Curve information which represents a shape of the edge, such as a straight line and an arc, and stored and managed in the internal storage device 201. The Vertex is associated with coordinate values in a three-dimensional space and stored and managed in the internal storage device 201.

The topology elements, such as Shell, Face, Loop and Vertex, are each associated with attribute information in the internal storage device 201.

Here, as an example, one method of managing Face information in the internal storage device 201 will be explained.

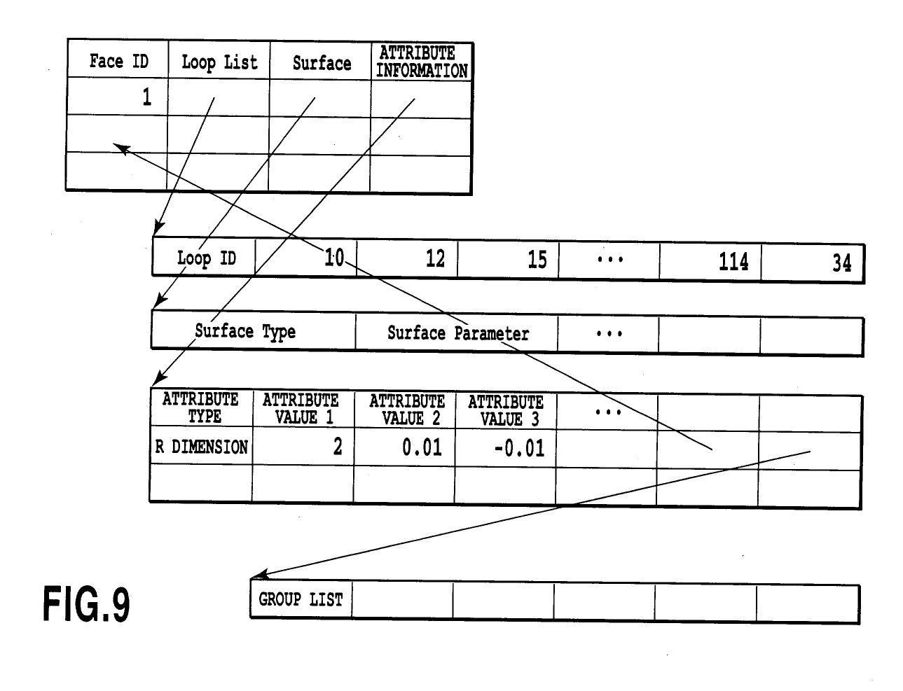

FIG. 9 is a conceptual diagram showing a method of managing Face information in the internal storage device 201.

As shown, the Face information comprises a Face ID, a pointer to a list of Loops making up the Face, a pointer to Surface data describing the shape of the Face, and a pointer to the attribute information.

The Loop list stores in a list the IDs of all the Loops making up the face. The Surface information comprises a Surface type and a Surface parameter corresponding to the Surface type. The attribute information has attribute type and attribute values corresponding to the attribute type. The attribute values include a pointer to the Face and a pointer to a group to which the attribute belongs.

<<Entering of Attribute Information and Displaying of Projected Figures of 3D Model>>

Next, a process of entering attribute information into a 3D model and of displaying the 3D model attached with the attribute information and projected figures of the model will be explained in detail.

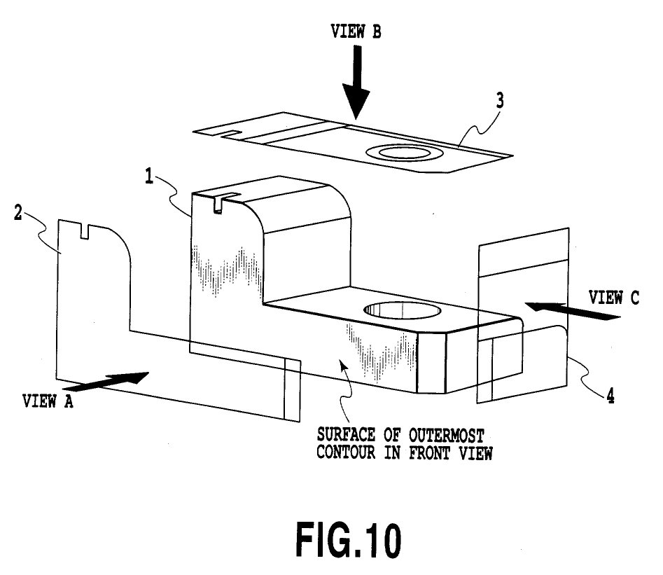

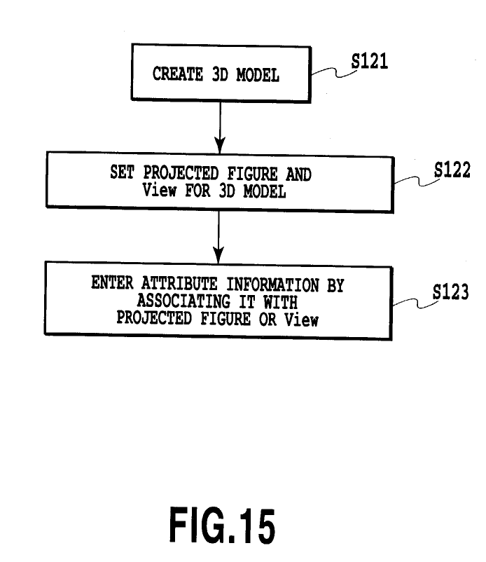

FIGS. 10 to 14 show a 3D model, projected figures and attribute information, and FIGS. 15 to 17 are flow charts showing a sequence of operations performed to add projected figures and attribute information to the 3D model.

In step S121 of FIG. 15, a 3D model 1 shown in FIG. 10 is generated. To add attribute information to the 3D model 1, step S122 sets necessary projected figures.

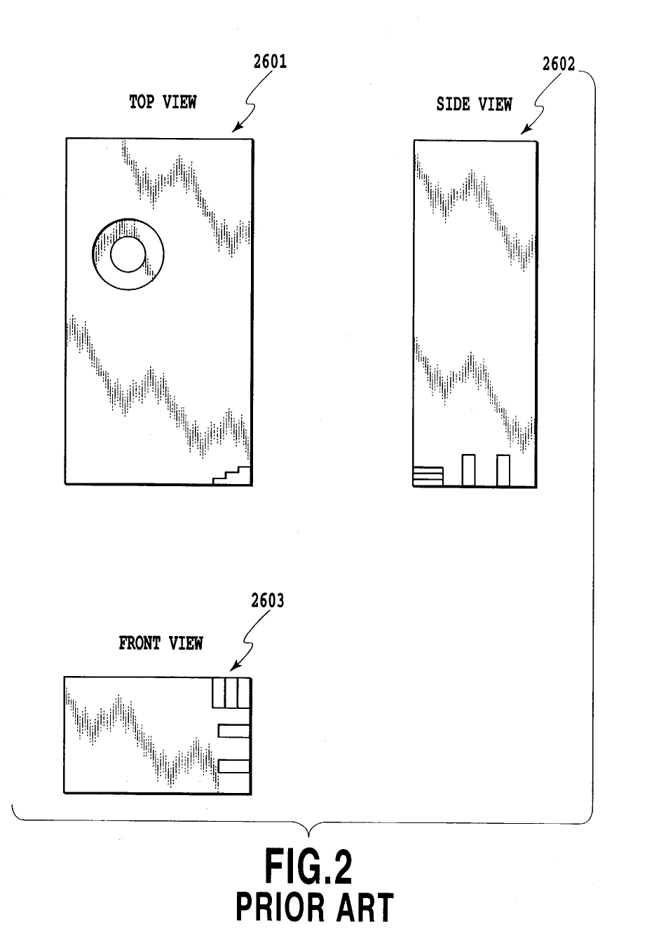

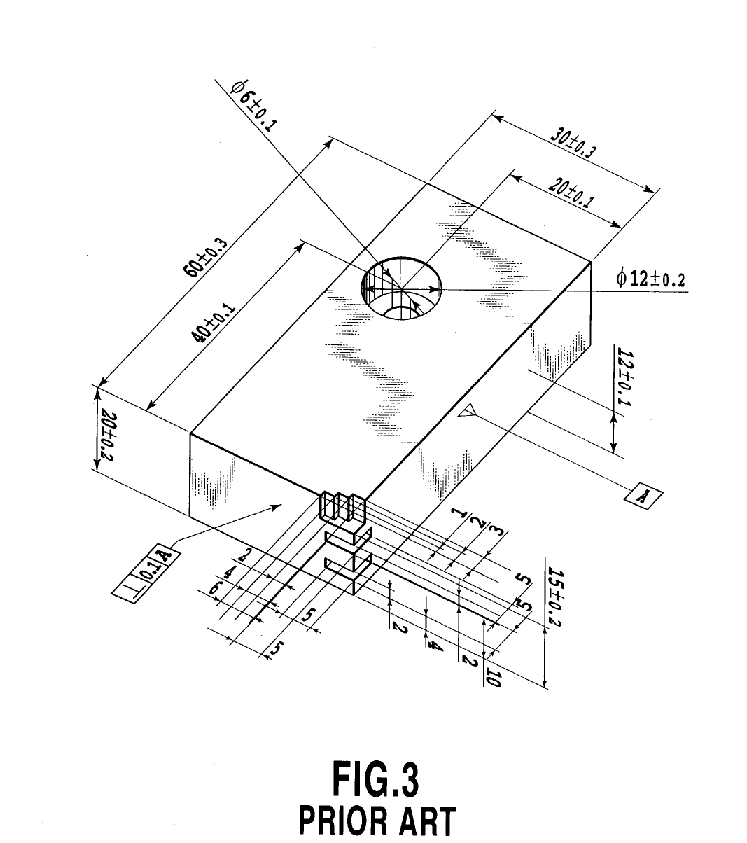

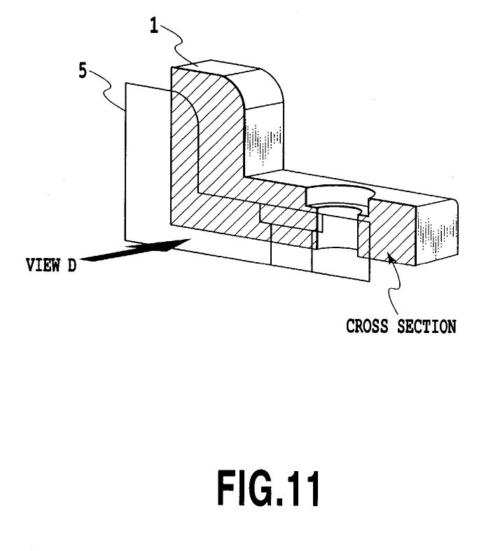

The projected figures may for example be a front view 2, a top view 3 and a side view 4 as shown in FIG. 10, and a section view 5 as shown in FIG. 11. The front, top and side projected FIGS. 2, 3, 4 are placed on surfaces of outermost contours of the 3D model 1 or in a three-dimensional space at desired distances from the outermost contours of the 3D model

1. The outermost contour means a surface, ridge or vertex of the 3D model 1 that is located outermost with respect to the direction of projection (i.e., located closest to a projection plane on which the geometric model is projected). The projected section view 5 is placed on a cross-sectional plane of the 3D model 1 or in a three-dimensional space at a desired distance from the cross-sectional plane. Since these projected figures are arranged in the same three-dimensional space as the 3D model 1, three-dimensionally revolving and zooming in/out the 3D model 1 can result in the projected figures being revolved and zoomed in/out together with the 3D model

1. It is needless to say that any desired projected figures can be added or removed as needed.

A View is set according to projected figures. The View means a display method determined by a direction of line of sight or display direction, a magnification, and a visual center or display center. The View defines conditions for displaying the 3D model 1 in a (virtual) three-dimensional space. For example, in FIG. 10, a View A is set which has a sight line in the direction of projection of the front view. The 3D model 1 and the View A are associated with each other. The magnification and the visual center are determined so that the entire 3D model 1 and almost all of the attribute information assigned to the model can be seen on the display screen. For example, in this embodiment, the model is displayed with a 1× magnification and with the visual center located almost at the center of the top view. Similarly, a View B with a sight line extending in a direction perpendicular to the top view and a View C with a sight line extending in a direction perpendicular to the side view are also set.

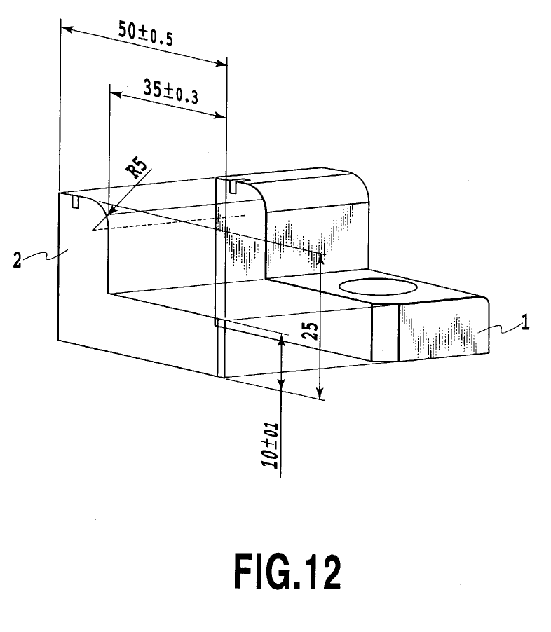

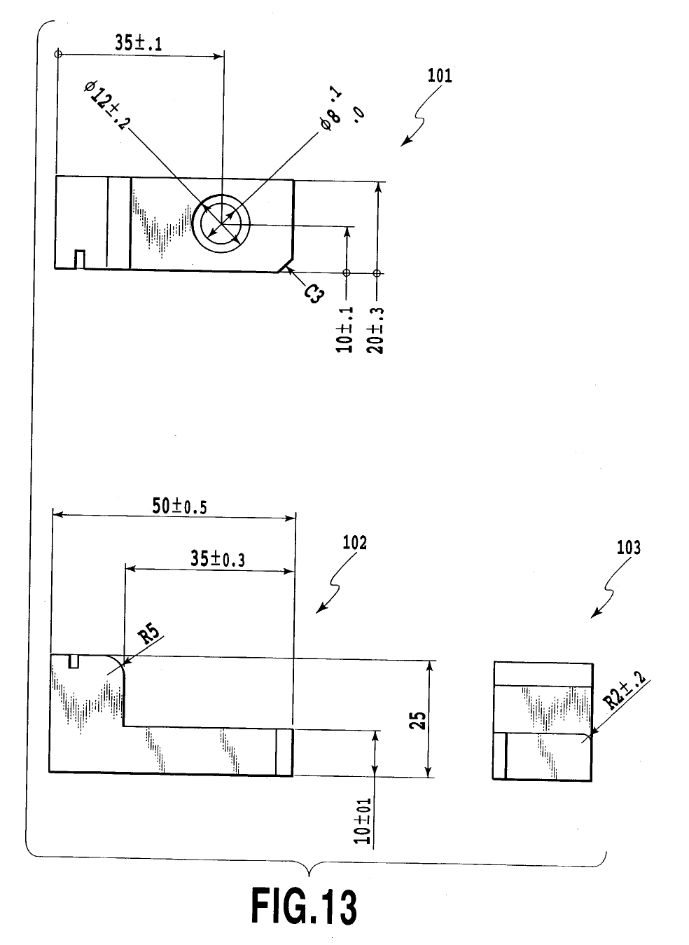

Next, in step S123, attribute information is associated with the projected figures or Views and entered so that the attribute information faces squarely in the direction of sight line of each View. FIG. 12 shows the attribute information assigned to the front view 2. In FIG. 13 reference numbers 102, 101 and 103 represent the 3D model 1 and attribute information as seen from the Views A, B, C. The attribute information is arranged on the same plane as the associated projected figures. The placement of the attribute information will be detailed later.

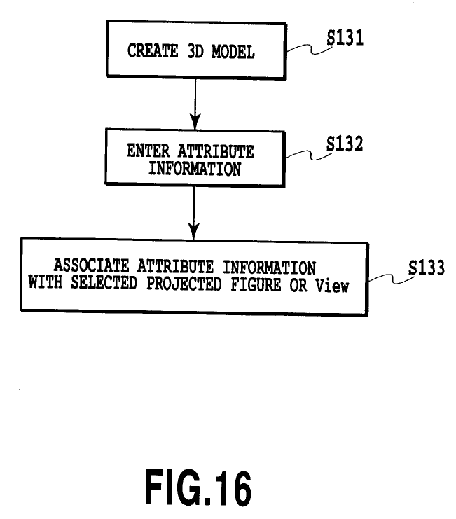

The association between the Views as projected figures and the attribute information may be made after entering the attribute information. For example, as shown in the flow chart of FIG. 16, the 3D model 1 is first generated (step S131) and then the attribute information, after having been entered in step S132, is associated with a desired projected figure in step S133. Further, the attribute information associated with the projected figures can be modified, as by addition or deletion.

The attribute information may also be entered by two-dimensionally displaying the 3D model 1 and the desired projected figure. Alternatively, the attribute information may be entered by displaying three-dimensionally, as necessary. This can be realized with the same number of steps as required to generate two-dimensional drawings using a 2D-CAD. Further, since the attribute information can be entered while three-dimensionally watching the 3D model 1 as needed, the data input can be made efficiently without errors.

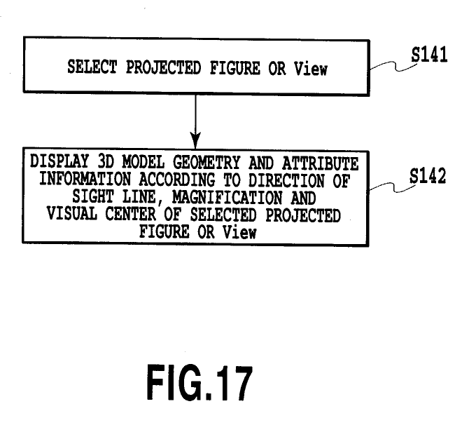

Next, the attribute information of the 3D model 1 can be displayed as follows. First, a desired projected figure is chosen in step S141 in FIG. 17. This is followed by step S142 which, according to the direction of sight line, the magnification and the visual center associated with the selected projected figure, displays the attribute information associated with the geometry of the 3D model 1 and with the projected figure or View.

The selection of a projected figure can easily be made by specifying a visible outline of the projected figure. It is also possible to display a list of names of selectable projected figures and select a desired one from the list. To make the Views easily selectable, the selectable Views of the 3D model 1 are properly stored and managed and represented in the form of icons on the display screen. For example, when View A, View B or View C is selected, 102, 101 or 103 of FIG. 13 is displayed on the screen. Whichever View is chosen, since the attribute information is placed at right angles to the direction of View, it is very easily readable two-dimensionally on the screen.

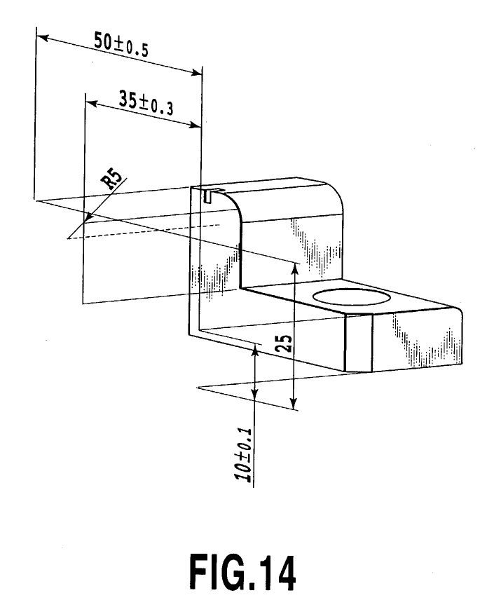

Further, in the case where the 3D model 1 is rotated for three-dimensional view, since the projected figures and the attribute information are related with each other and arranged on the same plane, they are very easily recognizable. For example, a comparison between FIG. 12 and FIG. 14 shows that the presence of the projected FIG. 2 makes the positions that the attribute information refers to more clearly identifiable.

<<Other Methods of Entering Attribute Information>>

In the above explanation about entering attribute information with reference to FIGS. 10 to 17, individual projected figures are related to individual pieces of attribute information. The association is not limited to this method. For example, the attribute information may be grouped and then the group may be associated with the projected figures.

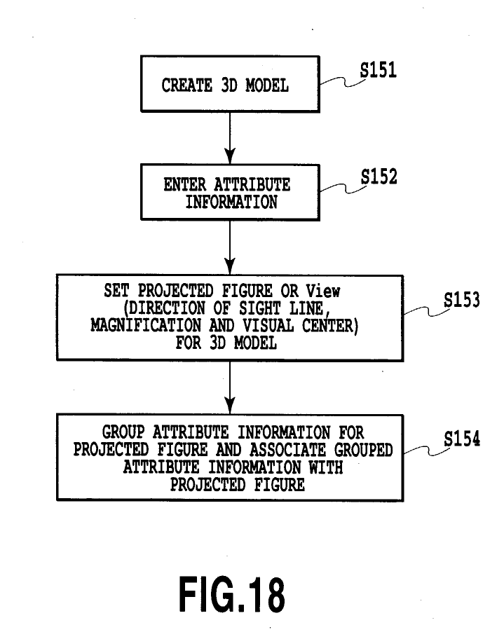

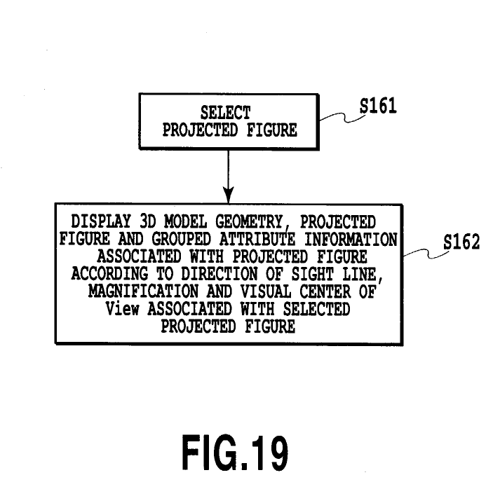

Referring to the flow charts of FIG. 18 and FIG. 19, the other input methods will be described.

The attribute information that was entered in advance is grouped selectively or according to a search result, and the grouped attribute information is associated with a desired projected figure. This produces a result and effect similar to those described above. The attribute information associated with the projected figure can be manipulated by making modifications, such as addition or deletion, to the group of attribute information.

That is, a 3D model 1 is generated (step S151), attribute information is entered (step S152), and projected figures are set for the 3D model 1 (step S153). Then, the attribute information entered in step S152 is grouped, and the grouped attribute information is associated with the set projected figures (step S154).

For display, a desired projected figure is selected as shown in FIG. 19 (step S161), and then the attribute information associated with the selected projected figure is displayed on the display 204 according to the information on the direction of sight line, the magnification and the visual center of the View associated with the selected projected figure (step S162).

<<Setting of Projected Figure of Cross Section>>

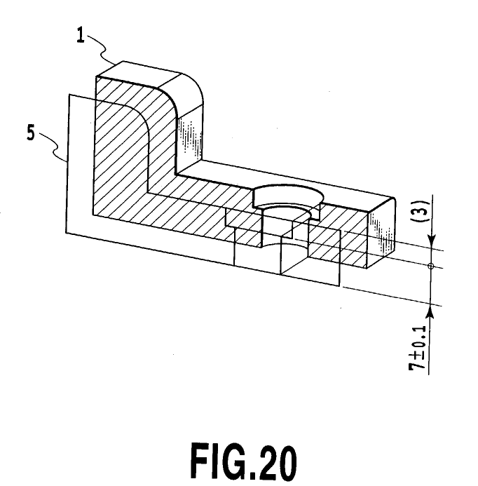

The projected section view 5 will be given more detailed explanation by referring to FIG. 20. A cross-sectional plane is set at a desired position in the 3D model 1 (e.g., the plane may pass through the center of a hole and extend parallel to the front view), and a View D is set by taking a direction normal to the front or back side of the cross-sectional plane as the direction of sight line. For example, the section view of the 3D model 1 can be displayed by undisplaying the front side of the cross-sectional plane with respect to the sight line direction. The projected section view 5 is arranged on the cross-sectional plane or in a three-dimensional space at a desired distance from the cross-sectional plane toward a direction opposite the sight line direction. By entering the attribute information and associating it with the projected FIG. 5 or View D, it is possible to display the attribute information in such a manner that the operator, when he or she looks at the two- or three-dimensional section view, can easily and quickly understand the portions the attribute information refers to.

<<Setting of Two or More Projected Figures>>

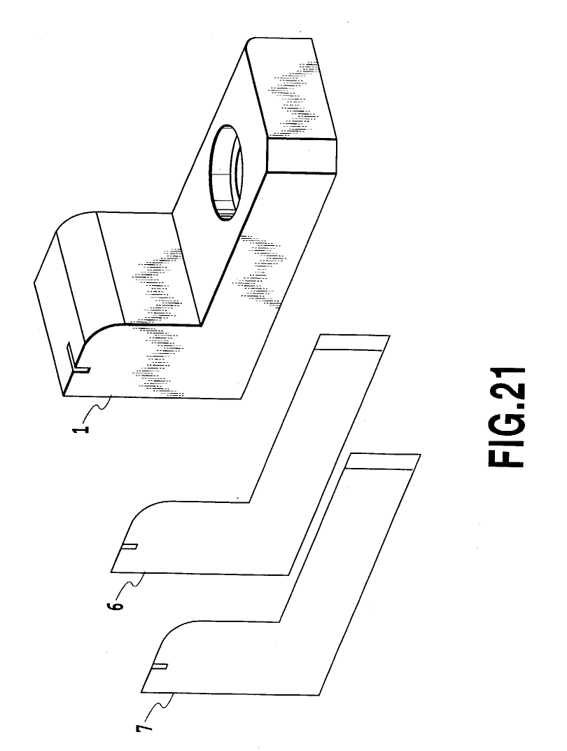

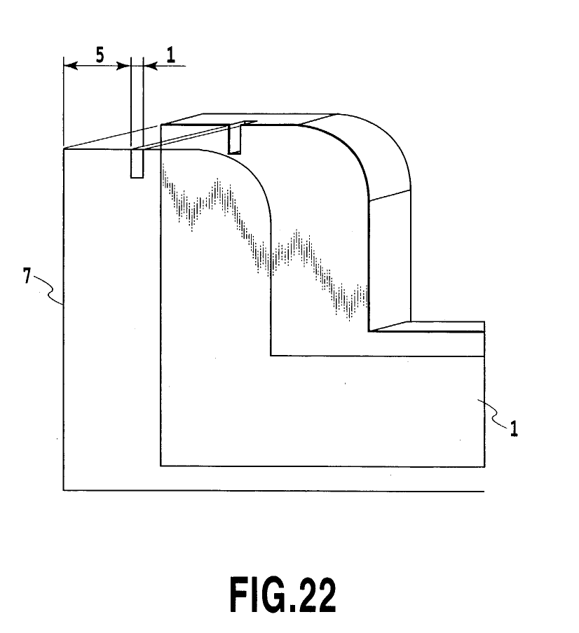

It is also possible to set a plurality of projected figures (including section views) of the same shape for the 3D model 1. FIG. 21 shows a plurality of projected figures that are projected in the same direction. The sight line directions of the Views associated with the projected figures are the same. In FIG. 21, a projected FIG. 6 and a projected FIG. 7 correspond to the front view of the 3D model 1. By grouping and associating the attribute information with the individual projected FIGS. 6, 7, the attribute information can be made more readable. For example, the projected FIG. 6 may be associated with attribute information concerning a rough external dimension of the 3D model and the projected FIG. 7 may be associated with a detailed shape of the 3D model (FIG. 22). In that case, the magnifications of the Views associated with the projected FIGS. 6, 7 can be given different settings. For example, the magnification of the View associated with the projected FIG. 6 is set to 1 and the magnification of the View associated with the projected FIG. 7 is set to 2. This arrangement makes the attribute information concerning the detailed shape easily recognizable.

In setting a plurality of projected figures, it is possible to set the projected figures according to the kind of attribute information with which they are associated, for example, setting one projected figure for attribute information concerning the hole position and hole shape and another projected figure for attribute information concerning secondary processing such as printing and painting.

<<Placement of Attribute Information>>

To display a 3D model and attribute information to be added to the 3D model on a screen in a manner that makes them very easy to read as a two-dimensional drawing, an operator selects or groups together a plurality of pieces of attribute information on that portion of the 3D model that the operator wants displayed, and associates them with a projected figure. In a two-dimensional representation, the attribute information needs only to be arranged on an area perpendicular to the direction of projection of the associated projected figure, i.e., perpendicular to the direction of sight line of the View. In a “3D drawing” which assigns attribute information to a 3D model, however, some improvements are needed to take full advantage of the merits of 3D model.

One of the merits of 3D model is that, since an object can be represented on the screen as a three-dimensional shape closely resembling the real object, an operator generating a 3D model or operators in the subsequent processes using the generated 3D model (process designer, mold designer/manufacturer, persons making measurements, etc.) can eliminate a work of transforming the drawing from two dimensions to three dimensions (this is done mainly in the mind of the operator) which is required in handling two-dimensional drawings. This transforming work depends largely on the ability of individual operators and it is in this transformation process that erroneous conversions leading to wrong fabrication and time loss are likely to occur.

To keep the merit of the 3D drawing that an object can be represented three-dimensionally, some improvements need to be made on the way the attribute information is shown (placement of the attribute information) when a 3D model is three-dimensionally displayed.

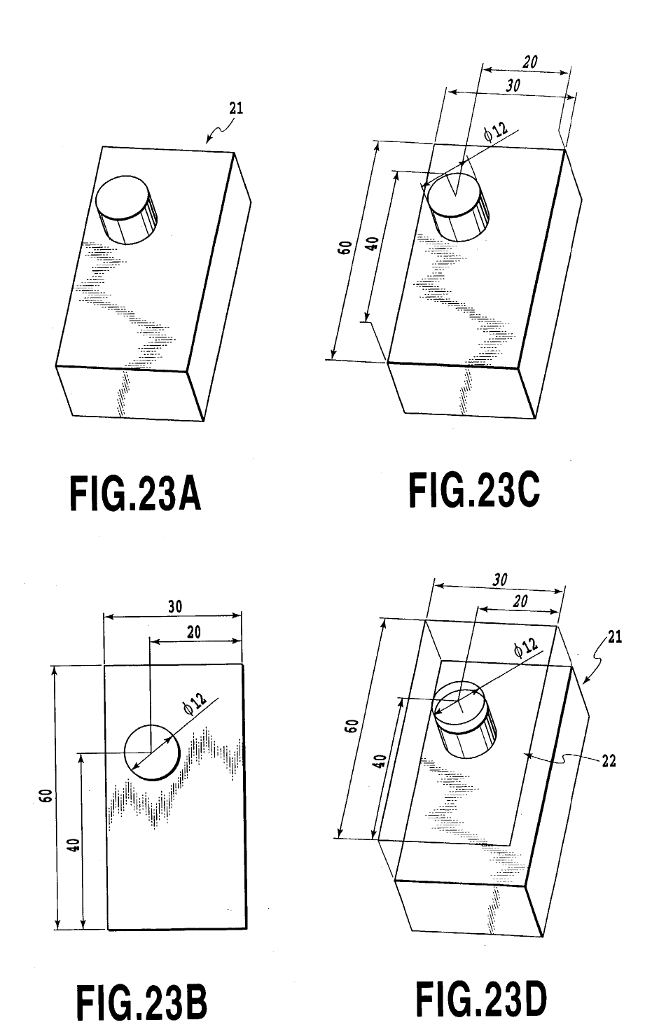

The improvements will be explained by referring to FIGS. 23A to 23D.

A first improvement is on a plane on which the attribute information is placed.

FIG. 23A is a perspective view of a 3D model 21 used for explanation. FIG. 23B is a top view of the 3D model 21. FIG. 23C is a perspective view showing the attribute information added to the 3D model 21 without making any improvements. FIG. 23D is a perspective view showing the attribute information with improvements made on its placement.

First, to create a top view of the 3D model 21, a projected FIG. 22 and a View are generated and associated attribute information is entered. The 3D model 21 as seen from the direction of sight line of this View is shown in FIG. 23B.

Regarding the input of the attribute information, if planes on which a plurality of sets of attribute information are placed are staggered as shown in FIG. 23C, the sets of attribute information overlap, making them difficult to read. Even in FIG. 23C, with only a small volume of attribute information, it is not easy to read. If the object has a more complicated shape, it is easily imagined that the attribute information will no longer be useful information and, in a perspective view, will make the drawing unintelligible.

However, by arranging the attribute information on the same plane as the projected view 22, as shown in FIG. 23D, the sets of attribute information can be prevented from overlapping each other, with the result that the attribute information can be recognized as easily as in a two-dimensional representation (FIG. 23B).

Thus, a drawing that adds attribute information to the 3D model 21 (three-dimensional drawing) can not only be used as a two-dimensional drawing but also as a three-dimensional drawing because this arrangement offers the 3D model merit of being able to present the attribute information in an easily recognizable manner even during a three-dimensional representation of the 3D model 21.

What has been explained above also applies to the case where attribute information is associated with a plurality of projected figures that are created in the same direction of sight line.

Further, when a plurality of projected figures are created in the same direction of sight line, it is preferred that they be put apart from each other (FIG. 21). When a plurality of projected figures and the attribute information associated with them are to be displayed simultaneously, if the projected figures are created on the same plane, the attribute information placement planes lie on the same plane. As a result, the attribute information overlaps when seen not only in the direction of sight line but also in a diagonal direction deviated from the line of sight, making them undistinguishable. The primary reason for putting attribute information on a plurality of projected figures is that the volume of attribute information is too large to put in a single projected figure when seen from one direction. It is therefore unavoidable that the attribute information becomes overcrowded when multiple sets of attribute information are displayed simultaneously.

Although it cannot be helped that the attribute information is crowded when seen from the direction of sight line, it is effective to arrange the projected figures, that were created in the same direction of sight line, apart from each other in making the attribute information more recognizable when seen at an angle.

A second improvement is on the method of extracting attribute information.

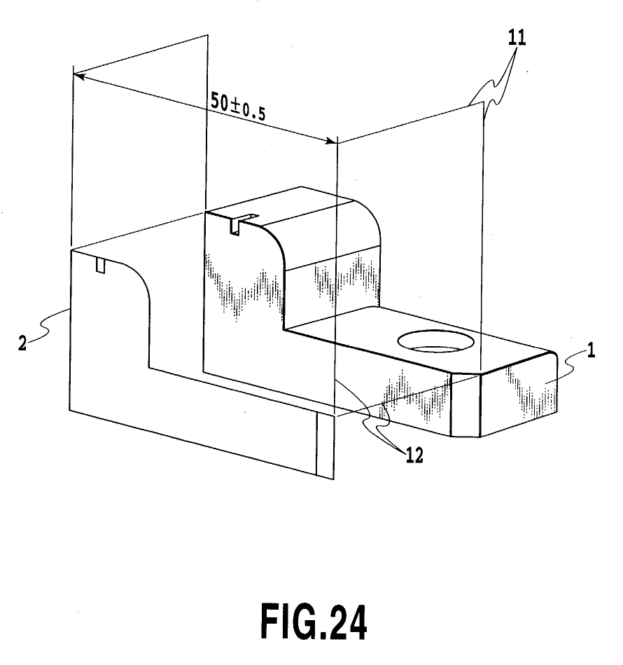

To extract the attribute information from the 3D model onto a plane in a three-dimensional space on which a projected figure is placed, leader lines or extension lines need to be bent and extended, like L-shaped lines. There are two possible methods of extraction. One is to bend the lines on the 3D model 1 side as shown in FIG. 24 (by extracting the attribute information from the 3D model 1 and then, at the dimension line position, moving it onto the plane of projected FIG. 2; this is represented by lines 11). The other is to bend the lines on the plane of the projected figure (by connecting the 3D model 1 and the projected figure with lines and then extracting the attribute information on the plane of the projected FIG. 2; this is represented by lines 12). In this invention, to associate the attribute information with the projected figures, the method of bending the lines on the plane of the projected figure is preferred. This method makes clearly recognizable which portion in the projected figure the attribute information refers to. This method therefore can take full advantage of the merit of the 3D model.

<<Magnification>>

Next, a magnification of View associated with a projected figure will be explained. The magnification refers to a factor by which a 3D model geometry and a projected figure in a (virtual) three-dimensional space is shown magnified or contracted on the display 204. By setting the magnification to an appropriate value, it is possible to make a complex shape or detailed shape more easily recognizable. Further, a large shape can be reduced in size for better understanding of an overall geometry of the object.

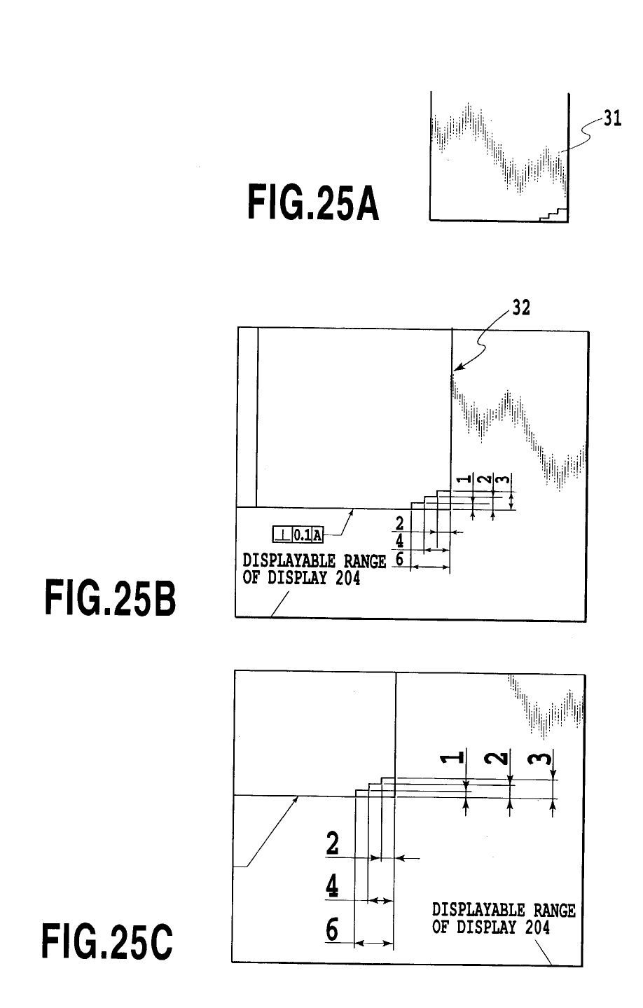

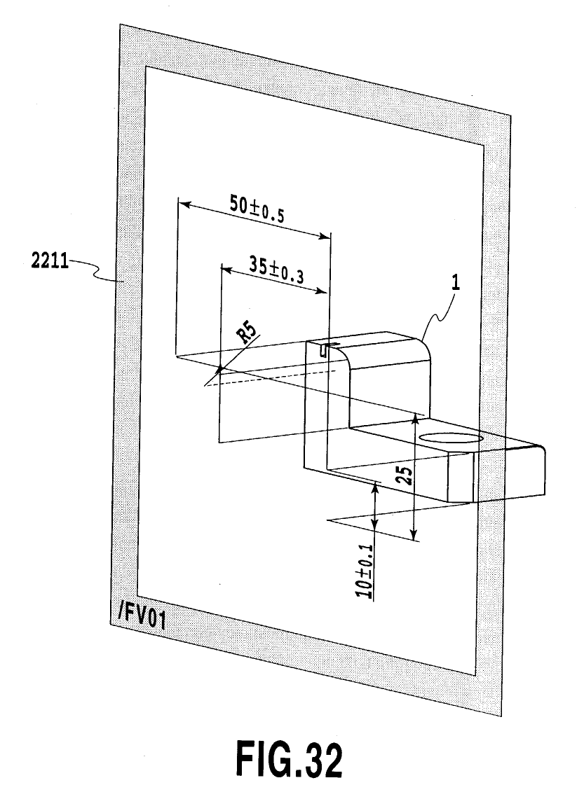

FIGS. 25A to 25C are partly enlarged views of a 3D model 31. For example, as shown in FIG. 25A, a View is set by directing the sight line toward a projected FIG. 32 corresponding to a top view of the 3D model 31, setting the visual center near a corner of an object, and setting the magnification to five times (5×). This setting enables a stepped geometry and its attribute information to be displayed very intelligibly (FIG. 25B).

This Embodiment 1 is applicable to general 3D-CAD irrespective of hardware making up the 3D-CAD equipment or the method of building the 3D geometric model.

Further, the size of the attribute information associated with the projected FIG. 32 (height of letters and symbols) is changed according to the magnification of the View associated with the projected figure (FIG. 25B).

The size of the attribute information (e.g., in mm) is defined to be a size it has in a virtual three-dimensional space in which the 3D model 31 exists (not the size when displayed on the display 204).

Suppose, for example, the attribute information has a size of 3 mm in the projected FIG. 32 when the magnification is 1×. An example of displaying the projected FIG. 32 with a magnification ×5 and with a letter height of 3 mm is shown in FIG. 25C. Since the attribute information associated with the projected FIG. 32 is displayed with a magnification ×5, its size is 15 mm. The increased size may be good for seeing but the 15-mm size is more than necessary. When there is other information that the operator wants to see at the same time, such a large size is not preferable.

In FIGS. 25B and 25C, a rectangular line represents a displayable range of the display 204.

If the attribute information is arranged not to overlap, the attribute information position is located away from the 3D model and projected figure, so that the association between the geometry and the attribute information becomes unintelligible, leading to possible misreading. Further, when a large volume of attribute information is to be displayed, all the information may not be able to be displayed on the display 204 and, in that case, the operator must change a display range to see the attribute information outside the current displayable range.

When the attribute information is to be displayed in a reduced size (magnification is less than 1×) and if the letter size is not changed, the attribute information becomes unintelligible because a displayed size of the attribute information on the display 204 decreases in a reduction display mode.

It is therefore desirable to change the size of attribute information according to the magnification, considering the conditions in which the attribute information is displayed.

Hence, it is appropriate to set the magnification and the size of attribute information almost inversely proportional to each other. Take for example a case in which the size of attribute information is set to 3 mm when the magnification of a View associated with a projected figure is 1×. If the magnification of the projected FIG. 32 is 5×, the size of the associated attribute information is set to 0.6 mm.

If the attribute information already associated with an arbitrary projected figure is now associated with another projected figure, the size of the attribute information is changed according to the magnification of the View associated with the destination projected figure.

<<Selection of Multiple Projected Figures>>

In the above Embodiment 1, when the attribute information associated with a projected figure is to be displayed, the number of projected figures selected has been described to be only one. In view of the object of this invention, there is no problem if two or more projected figures are selected.

It should be noted, however, that although the selection of a single projected figure produces only one each of direction of sight line, magnification and visual center and thus specifies only one display method, the selection of a plurality of projected figures results in two or more display methods. The latter case therefore requires some additional means of control. For example, when a plurality of projected figures are selected, it is possible to display all the attribute information associated with the selected projected figures to allow an operator to choose a desired View setting for the direction of sight line, the magnification and the visual center.

Further, an improvement is made as by changing color of the attribute information for each projected figure to make the groups of attribute information easily distinguishable.

<<Method of Displaying Attribute Information>>

In selectively displaying attribute information assigned to a 3D model, a conventional method has been described to consist in selecting View as a projected figure and then displaying the attribute information associated with the projected figure as needed. The method for selective display of attribute information is not limited to this sequence of operations. For example, another possible method may involve selecting attribute information and then displaying the 3D model, the projected figure and the attribute information according to a direction of sight line, a magnification and a visual center of the View to which the attribute information is related.

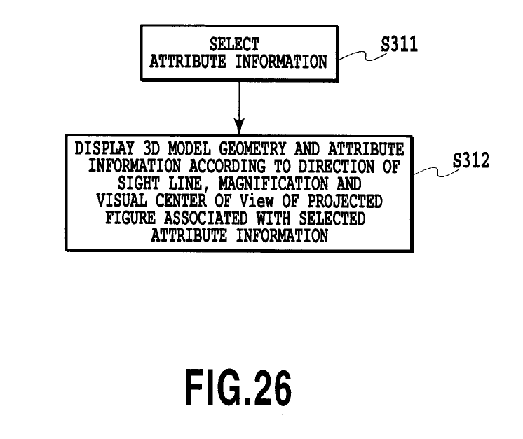

FIG. 26 is a flow chart showing the sequence of operations described above.

With the 3D model 1 and the attribute information displayed as shown in FIG. 12 (attribute information associated with other projected figures may also be displayed at the same time), attribute information (for example, 35±0.3) is selected (step S311).

This selection causes the 3D model 1, the projected figure and the attribute information to be displayed according to the direction of sight line, the magnification and the visual center of the View associated with the projected figure to which the attribute information is related (step S312). In this case, a front view indicated at 102 in FIG. 13 is displayed.

As a result, the relation between the selected attribute information and the 3D model 1 is shown two-dimensionally, contributing to an improved ease of recognition.

Another effective method may also involve selecting geometry information on the 3D model (edge, face and vertex), displaying the attribute information associated with the geometry information, and also displaying the 3D model, the projected figure and the attribute information according to the direction of sight line, the magnification and the visual center of the projected figure associated with the attribute information.

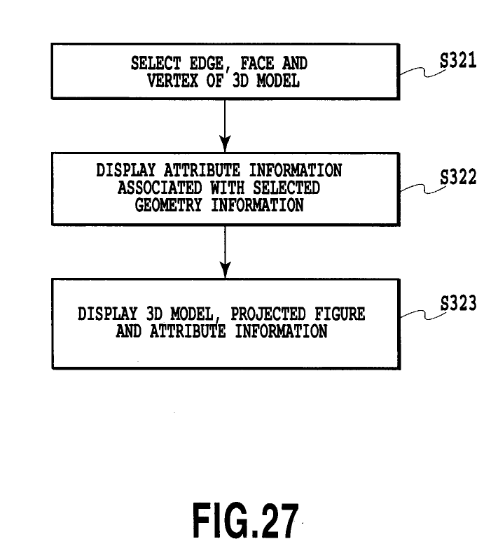

FIG. 27 is a flow chart showing this sequence of operations (from the selecting of attribute information to the displaying).

Geometry information on a 3D model is selected (S321).

Attribute information associated with the selected geometry information is displayed (step S322).

If there are a plurality of pieces of associated attribute information, all of them may be displayed. It is also possible to display all attribute information belonging to the projected figures associated with the attribute information.

Next, according to the direction of sight line, the magnification and the visual center related to the projected figure associated with the displayed attribute information, the 3D model, the projected figure and the attribute information are displayed (step S323).

As described above, since a search for related attribute information can be made from geometry information on a 3D model and the searched attribute information can be displayed, this system is very easy to use.

<<Displaying>>

Here, an explanation will be given as to how the 3D model assigned with the attribute information generated as described above is displayed.

The 3D model attached with attribute information, which was generated by the information processing apparatus of FIG. 5, is transferred from the information processing apparatus through an external connection device to similar information processing apparatus in the subsequent processes of FIG. 4 where the transferred data can be used and displayed.

An operator, who is also a designer or engineer of a product, unit and part, can add new attribute information to the 3D model by displaying the 3D model he or she generated as shown at 101, 102 and 103 in FIG. 13, as if he or she was writing a two-dimensional drawing. When the shape is complex, it is also possible to display three-dimensional and two-dimensional representations of the 3D model alternately or simultaneously on the same screen as needed and enter desired attribute information efficiently and accurately.

Further, an operator responsible for checking and approving the generated 3D model can display the 3D model's views as shown at 101, 102 and 103 in FIG. 13 all at once or alternately on the same screen, examine the model and add attribute information including markings, symbols and colors signifying check results, such as “checked,” “OK,” “no good,” “reserved,” or “reexamination required.” It is of course possible to perform examinations by making comparison and reference checks among a plurality of products, units and parts, as necessary.

Further, engineers and designers other than the one who created the 3D model can reference and use the generated 3D model in designing other products, units and parts. By referencing the 3D model one can easily understand the intention of the designer and the design technique.

In building and manufacturing a 3D model, an operator responsible for adding necessary information to the 3D model or attribute information can use this system. In this case, the operator may be an engineer in charge of setting a manufacturing process for a product, unit and part. The operator may, for example, specify a kind of process and tools to be used, or add edges, corners, and corner rounding and chamfering specifications necessary for machining the 3D model. The operator may also specify the method of measuring dimensions and dimensional tolerances, add measuring points to the 3D model, or enter information on precautions to be taken in a measuring process. These can be done efficiently and reliably by the operator as he or she watches the easy-to-see displayed views, such as shown at 101, 102 and 103 in FIG. 13, and a three-dimensional shape of the model as needed.

In building and manufacturing a 3D model, this system can also be used by an operator who is in charge of collecting information necessary for making desired preparations from the 3D model or attribute information. In this case, the operator may be an engineer who designs a mold, a jig and various devices necessary for building and manufacturing the model. The operator, while watching and examining the three-dimensional shape of the 3D model, checks and extracts necessary attribute information from the easy-to-see displayed views, such as shown at 101, 102 and 103 in FIG. 13. Based on the extracted attribute information, the operator designs a mold, a jig and various devices. When the operator is a mold designer, for example, he or she examines the 3D model and attribute information to determine the construction of the mold in the design process. The operator also adds to the 3D model edges, corners, corner rounding and chamfering, as may be required, for the manufacture of the mold. Further, when the mold is for resin injection molding, the operator adds to the 3D model a gradient necessary for molding.

Further, this system can also be used by an operator who is in charge of manufacturing a product, unit and part. In this case, the operator may be a machining engineer or assembly worker for a product, unit and part. The operator, while watching the 3D model three-dimensionally, can easily understand a shape to be machined or a shape to be assembled and perform machining and assembling by checking it against the easy-to-see displayed views, such as shown at 101, 102 and 103 in FIG. 13. The operator examines the shape of the machined portion or assembled portion as needed. The operator then adds a result of machining work, such as “machined” and “difficult to machine,” to the 3D model or the already assigned attribute information. These information may be fed back to the design engineer.

Further, this system can also be used by an operator responsible for inspection, measurement and evaluation of a manufactured product, unit and part. In this case, the operator may be an engineer for inspecting, measuring and evaluating the product, unit and part. While watching the easy-to-see displayed views, such as shown at 101, 102 and 103 in FIG. 13, or three-dimensionally examining the model, the operator can efficiently and reliably obtain information on the method of measuring the dimensions and dimensional tolerances, on the measuring points and on precautions to be taken during the measuring process and make inspections, measurements and evaluations. Then, the operator can add the results of inspections, measurements and evaluations as attribute information to the 3D model. For example, the result of measurements of the dimensions may be added. Further, attribute information on dimensions that are out of tolerances and on faulty or damaged portions, or markings or symbols representing these information may be added to the 3D model. As with the check results described above, markings, symbols or colors representing the results of inspections, measurements and evaluations may be added.

Further, this system can also be used by operators in a variety of divisions and roles involved in the development and manufacture of a product, unit and part. In this case, the operators may be a person in charge of analyzing the development and manufacturing costs, a person in charge of placing orders for a product, unit and part, and various related parts, and a person in charge of preparing manuals and packing materials for a product, unit and part. In this case, too, the operator can easily understand the shape of a product, unit and part by three-dimensionally checking the 3D model and proceed to perform a variety of tasks efficiently while watching the easy-to-see displayed views, such as shown at 101, 102 and 103 in FIG. 13.

<<Inputting of Inspection Specifications>>

Next, how inspections are specified will be explained.

To inspect a finished mold and part, a 3D model is assigned with dimensions and other information before being displayed, as described above.

Here, attribute information is entered into a set projected figure in such a manner as will make clear what portions should be inspected.

That is, for the surfaces, curves and edges making up the 3D model, the order of inspection, the positions to be inspected and the items to be inspected are input. By performing inspections according to the specified order, the number of inspection steps can be reduced.

First, items and positions to be inspected are entered to be associated with the entire 3D model. This is followed by determining the order of inspections according to a predetermined method to allocate specific sequence numbers to individual items. In performing the actual inspection, specifying a sequence number causes the associated projected figure to be selected for display and the surfaces of the 3D model to be inspected are displayed in a form (e.g., color) different from other surfaces, clearly indicating the inspection positions.

Then, for each inspection item specified, a result of inspection is entered to decide whether remolding is needed or not.

According to the Embodiment 1 of this invention, as described above, it is possible to obtain an easy-to-see displayed view with a simple manipulation. Further, with the displayed view an operator can understand the relation between the direction of sight line and the attribute information at a glance. Further, since dimension values are entered in advance, misreading of these values due to erroneous operations on the part of the operator can be reduced.

Further, since only the information associated with the direction of sight line can be displayed, the necessary information can be found easily.

A large volume of attribute information associated with the same direction of sight line can be assigned to a plurality of projected figures so that data can be made easily recognizable and necessary information found quickly.

Further, by setting a projected figure in an interior of the 3D model, i.e., on a cross section, the attribute information can be displayed intelligibly.

Further, since the size of the attribute information is changed according to the display magnification of a View associated with the projected figure, the attribute information can be displayed appropriately for easy reading.

Further, by placing the attribute information on a projected figure, the attribute information can be read even if the 3D model is viewed at an angle.

From the attribute information, it is possible to search for a desired projected figure and see only the information associated with that projected figure. This enables an operator to know the necessary information easily and quickly.

Furthermore, from geometry information, it is possible to search for desired attribute information and projected figure and also to view only the information associated with that projected figure. The operator can therefore obtain the necessary information easily and quickly.

Embodiment 2

Next, Embodiment 2 embodying the present invention will be detailed by referring to the drawings.

<<Overall Flow in Manufacturing a Mold>>

FIG. 4 shows an overall flow in a process of manufacturing a mold used for molding a part according to Embodiment 2 of this invention. In this Embodiment 2, explanations referring to FIG. 4 are similar to those given in connection with Embodiment 1.

<<Design of Product>>

Next, a process of designing a product and preparing drawings of individual parts will be explained. The parts drawings are generated by a 3D-CAD equipment.

Here, a designing of parts by using the 3D-CAD equipment, or information processing apparatus, of FIG. 5 will be explained. In Embodiment 2, explanations referring to FIG. 5 are also similar to those given in connection with Embodiment 1.

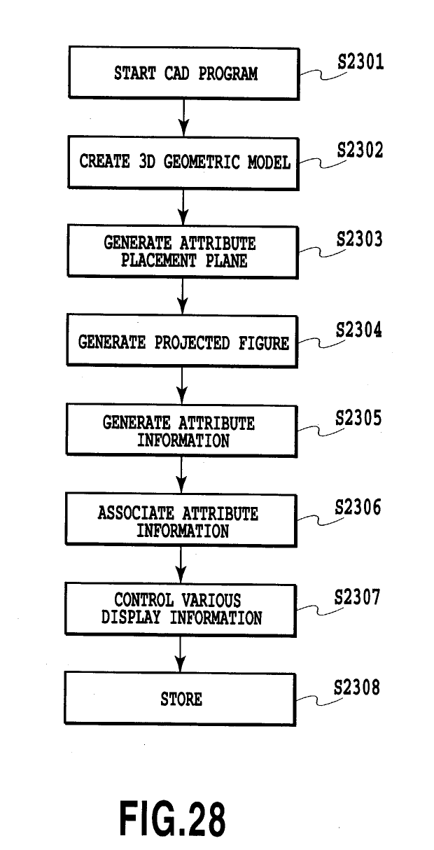

FIG. 28 is a flow chart showing a sequence of operations performed by the CAD equipment of FIG. 5.

First, when an operator instructs the CAD program to start using the input device 205, the CAD program stored in the external storage device 202 is read into the internal storage device 201 and is executed on the CPU 203 (step S2301).

The operator interactively gives instructions through the input device 205 to generate a geometric model on the internal storage device 201 which is then shown on the display 204 (step S2302). The geometric model will be described later. The operator can also specify a file name through the input device 205 to read the geometric model already generated on the external storage device 202 into the internal storage device 201 so that it can be handled on the CAD program.

Using the input device 205, the operator generates an attribute placement plane in the three-dimensional space in which the geometric model was created (step S2303).

In order that the position of the attribute placement plane is easily identifiable, the attribute placement plane is displayed in the form of image information such as a frame (double frame with an inner side of the frame painted). The setting information of the attribute placement plane is associated with the geometric model and stored in the internal storage device 201.

The generated attribute placement plane is preferably named as necessary.

Next, using input device 205, the operator creates a projected figure of a geometric model on the attribute placement plane. The projected figure is one of so-called primary six views, such as top view and front view, depending on the direction of the attribute placement plane, or a section view to which a cross section is projected (step S2304). While the projected figures preferably cover an entire model, it is also possible to selectively project surfaces or edges, or any desired part of the model.

Here, the projected figure and the attribute placement plane are associated with each other and the association information is stored in the internal storage device 201.

Next, the operator using the input device 205 adds dimensions, dimensional tolerances and texts (annotations) as attribute information to the geometric model (step S2305). The added attribute information can be displayed on the screen as image information such as a label together with the geometric model and the projected geometry. The added attribute information is associated with the geometric model and stored in the internal storage device 201.

Next, the operator using the input device 205 associates the attribute information with the attribute placement plane (step S2306). The association information on the attribute information and the attribute placement plane is stored in the internal storage device 201.

The operator may specify an attribute placement plane in advance and add attributes to the plane by associating them with the attribute placement plane. The operator can also set or eliminate the association between the attribute information and the attribute placement plane.

Next, the operator specifies an attribute placement plane using the input device 205 and performs a display control including displaying/undisplaying and coloring of the attribute placement plane, the projected figure associated with the attribute placement plane, and the attribute information, such as dimensional tolerances and texts (annotations), associated with the attribute placement plane (step S2307).

When generating an attribute placement plane using the input device 205, the operator sets a position of a viewpoint, a direction of sight line and a magnification for the attribute placement plane (step S2307). Setting the display information on the attribute placement plane and specifying the attribute placement plane can display the geometric model at a set position of viewpoint, in the set direction of sight line and with the set magnification. Since the attribute placement plane and the attribute information are associated with each other, it is possible to selectively display the attribute information associated with the specified attribute placement plane. The display information on the attribute placement plane is stored in the internal storage device.

The attribute information may be attached with an identifier before being stored in the external storage device 202. By using this identifier, the attribute data is associated with other data.

The attribute information on the external storage device 202 may be read into the internal storage device 201 and information may be added to update the attribute information.

Then, the operator using the input device 205 stores in the external storage device 202 a CAD attribute model which is the geometric model attached with the position information of the attribute placement plane, the projected figure on the attribute placement plane, the display information of the attribute placement plane, and the attribute information (step S2308).

Here, a geometric model and a CAD attribute model will be explained.

FIGS. 7A and 7B show examples of 3D geometric model and FIG. 8 is a conceptual diagram showing a relationship among parts making up the geometric model. In Embodiment 2, explanations referring to FIGS. 7A and 7B and FIG. 8 are similar to those given in connection with Embodiment 1.

Here, a method of data storage and management on the internal storage device 201 will be explained for an example case of Face information.

FIG. 9 is a conceptual diagram showing a method of managing Face information in the internal storage device 201. In Embodiment 2, explanations referring to FIG. 9 are similar to those given in connection with Embodiment 1.

<<Entering of Attribute Information and Displaying of Projected Figures of 3D Model>>

Next, a process of entering attribute information into a 3D model, generating an attribute placement plane and displaying the 3D model attached with the attribute information and a projected figure on the attribute placement plane will be explained in detail.

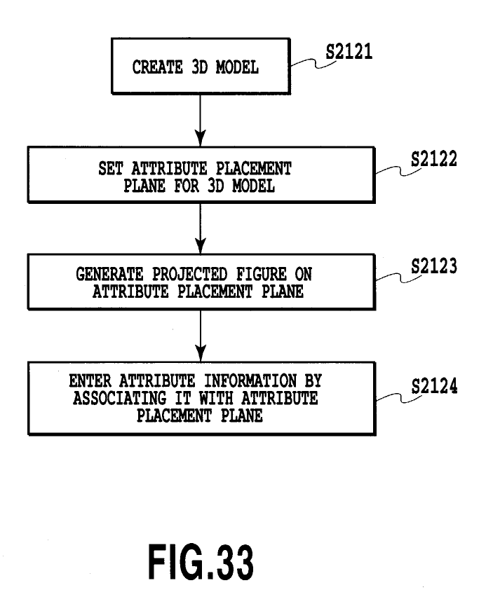

FIG. 13 and FIGS. 29-32 are diagrams showing a 3D model, attribute placement planes, projected figures and attribute information. FIGS. 33-35 are flow charts showing a sequence of operations performed to add an attribute placement plane, a projected figure and attribute information to a 3D model.

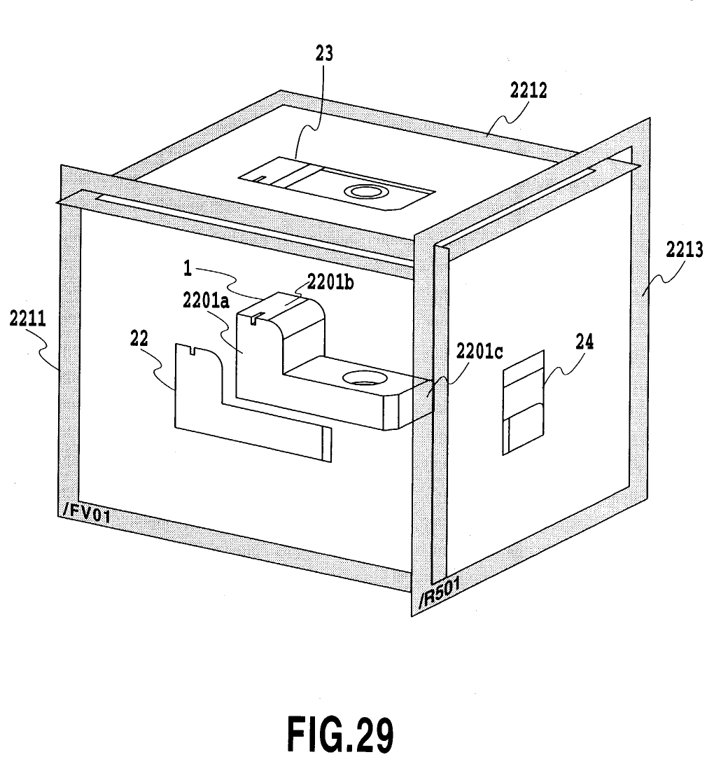

In step S2121 of FIG. 33, a 3D model 1 shown in FIG. 29 is generated. To add attribute information to the 3D model 1, step S2122 sets necessary attribute placement planes.

The attribute placement plane defines conditions under which the 3D model 1 and the attribute information attached to the 3D model 1 are displayed.

In Embodiment 2, the attribute placement plane is defined by a position of a point in a (virtual) three-dimensional space (hereafter referred to as a viewpoint) and a direction normal to the generated plane (direction of sight line). The attribute placement plane also has information on the 3D model 1 and on a display magnification of the attribute information added to the 3D model 1 (referred to simply as a magnification).

In other words, the position of viewpoint is a position in the direction of sight line at which the attribute placement plane is set. For example, the attribute placement planes 2211, 2212, 2213 are set 60 mm from the outermost contour of the 3D model 1 (FIG. 29).

Here, it should be noted that, on the attribute placement plane, which corresponds to the direction of sight line of a projected view in the third angle projection (front, top, left and right side, bottom and rear view), the content to be displayed is not affected by the position of the viewpoint as long as it is located outside the 3D model 1.

Further, the position of the viewpoint coincides with a center of the display 204 when the 3D model 1 and the attribute information attached to the 3D model 1 are displayed.

Next, at the position of viewpoint the direction of a normal is matched to the direction of sight line that is used to display the 3D model 1 and the attribute information attached to the 3D model 1.

The magnification is a factor by which a 3D model geometry in a (virtual) three-dimensional space is shown magnified on the display 204.

The position of viewpoint, the direction of sight line and the magnification, all parameters of the attribute placement plane, can be changed as needed.

For example, in FIG. 29, attribute placement planes 2211, 2212, 2213 are set in the direction of the front, plan and right side view, respectively. The direction of sight line is directed from the outside of the 3D model toward the inside. In FIG. 29, the attribute placement plane 2211 is parallel to a front surface 2201a of the 3D model 1, the attribute placement plane 2212 is parallel to a top surface 2201b of the 3D model 1, and the attribute placement plane 2213 is parallel to a side surface 2201c of the 3D model 1. The position of viewpoint and the magnification are set so that almost all of the shape of the 3D model 1 and of the attached attribute information can be displayed on the screen of the display 204.

To clarify the position of each attribute placement plane, they are bordered with rectangular frames. While this embodiment uses a rectangular frame for easy identification of the attribute placement plane, other shapes may be used. For example, a polygonal or circular shape may be used.

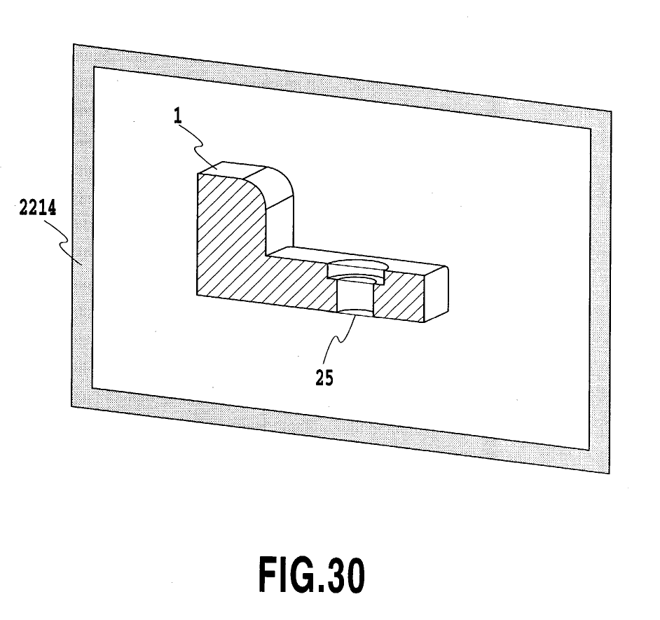

Next, projected figures are set (step S2123). The projected figure is an outline geometry of the 3D model 1 projected onto each of the attribute placement planes 2211, 2212, 2213. For example, as shown in FIG. 29, a projected FIG. 22 is set on the attribute placement plane 2211 corresponding to the direction of sight line of the front view; a projected FIG. 23 is set on the attribute placement plane 2212 corresponding to the direction of sight line of the top view; a projected FIG. 24 is set on the attribute placement plane 2213 corresponding to the direction of sight line of the right side view; and, as shown in FIG. 30, a projected FIG. 25 is set on the attribute placement plane 2214 corresponding to the direction of sight line of the section view. Desired projected figures can be seen by selecting all the attribute placement planes to project the external shapes all at once, or by selecting a single plane to project the shape on that plane, or by selecting two or more planes to project the shapes on these planes.

Since the attribute placement planes and the projected figures are placed in the same three-dimensional space as the 3D model 1, they can be rotated and zoomed in/out along with the 3D model 1 by three-dimensionally rotating and zooming in/out the 3D model 1. It is of course possible to add or delete the attribute placement planes and projected figures as needed.

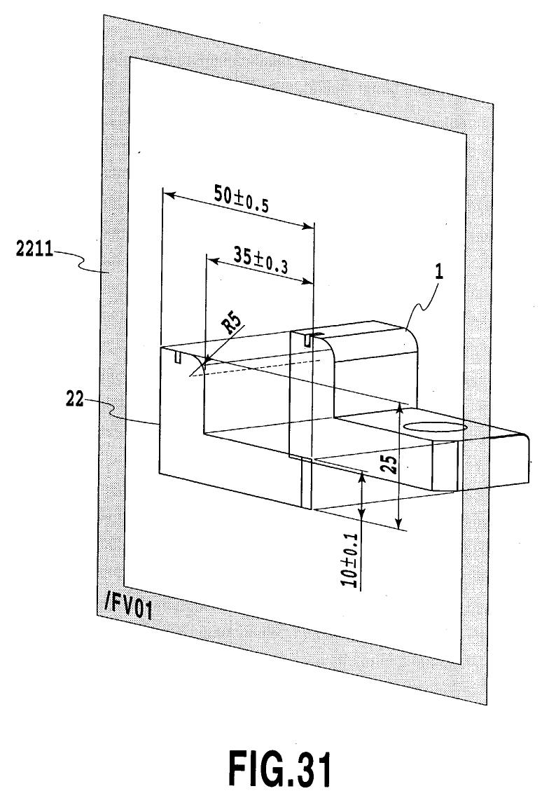

Next, in step S2124, attribute information is entered by associating it with the individual attribute placement planes so that the attribute information faces squarely in the direction of sight line of each attribute placement plane. FIG. 31 shows attribute information assigned to the attribute placement plane 2211 corresponding to the direction of sight line of the front view. In FIG. 13 reference numbers 102, 101 and 103 represent the 3D model 1, the projected FIGS. 22, 23, 24 and the attribute information as seen from the direction of sight line of each attribute placement plane. The attribute information is placed on the attribute placement planes as are the projected figures. Details of placement of the attribute information will be described later. In FIG. 13 the projected FIGS. 22, 23, 24 are displayed overlapping the shape of the 3D model 1.

The size of the attribute information (height of letters and symbols) associated with the attribute placement plane is changed according to the magnification of the attribute placement plane. The size of the attribute information (in mm) is defined to be a size it has in a virtual three-dimensional space in which the 3D model 1 exists (not the size when displayed on the display 204). When the attribute information is associated with another attribute placement plane, the size of the attribute information is changed according to the magnification of the destination attribute placement plane.

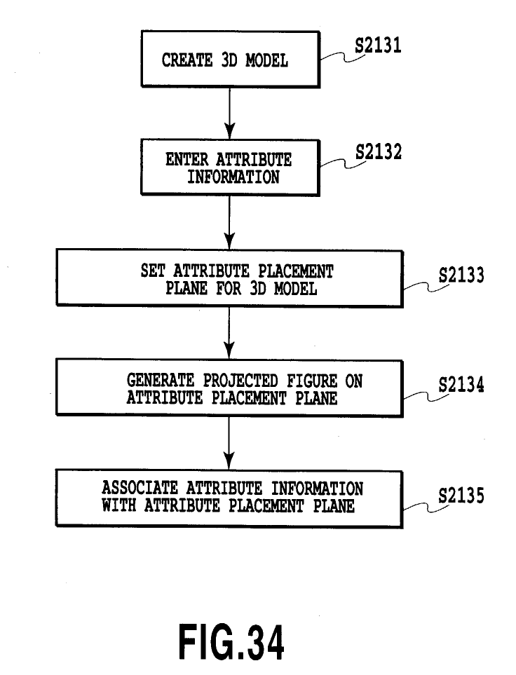

The association between the individual attribute placement planes and the attribute information may be made after the attribute information is entered. For example, as shown in the flow chart of FIG. 34, it is possible to create a 3D model 1 (step S2131), enter attribute information in step S2132, generate attribute placement planes and projected figures in steps S2133, S2134, and then associate the attribute information with the desired attribute placement planes in step S2135. The attribute information associated with the attribute placement planes can be added or deleted as needed.

The projected figures may be generated after the attribute information has been entered.

The attribute information may be entered by displaying the 3D model 1 and the desired projected figures two-dimensionally or three-dimensionally, as required. The inputting of attribute information can be realized with the same number of steps as required to generate two-dimensional drawings using a 2D-CAD. Further, since the attribute information can be entered while three-dimensionally watching the 3D model 1 as needed, the data input can be made efficiently without errors.

Next, how a 2D figure and text information are generated and edited on attribute placement planes will be explained. The 2D figure and text information may be used to represent, for example, the following information.

In the coordinate dimensioning, a table of symbols representing holes and of hole positions is prepared and edited.

In another case, when symbol are used instead of dimension values, separately displayed texts and values are prepared and edited.

In another case, when a dimension is assigned to an intersection of extensions of visible outlines, extension lines of the visible outlines are generated and edited to clarify the intersection.

Further, lines shown for reference to indicate the shapes and positions of adjoining portions, tools and jigs are generated and edited.

Narrow solid lines representing planes are generated and edited.

Further, to show tapers and gradients, leader lines are extracted from inclined surfaces to create and edit drawings and dimensions.

Further, lines indicating a range of special machining and texts on necessary times for special machining are generated and edited.

Further, letters associated with arrow views or partly enlarged views, or texts concerning magnification are generated and edited.

Further, center lines or hidden lines are added to the projected figures.

In each of the above cases, thick or narrow lines of so-called solid lines, dashed lines, one-dot chain lines and two-dot chain lines are used as necessary. It is also possible to specify colors for these lines, as needed.

These lines are generated by a variety of methods, such as specifying arbitrary two points on the attribute placement plane, specifying one point and a direction, and specifying a center and a radius. In generating a line, a 3D model 1 or projected figures are of course used as needed.

Various kinds of information described above are associated with and generated on the desired attribute placement planes. This enables design information to be represented more intelligibly and appropriately.

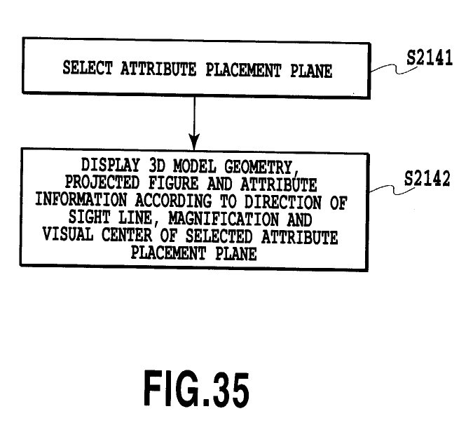

Next, how the attribute information of the 3D model 1 is viewed will be explained. In FIG. 35, step S2141 selects a desired attribute placement plane. In step S2142, this causes the shape of the 3D model 1 and the projected figure and attribute information associated with the selected attribute placement plane to be displayed according to the position of viewpoint, the direction of sight line and the magnification of the selected attribute placement plane. For example, when a attribute placement plane 2211, attribute placement plane 2212 or attribute placement plane 2213 is selected, the view indicated by reference number 102, 101 or 103 of FIG. 13 is displayed. Since the attribute information is arranged to face squarely in the direction of sight line of the attribute placement plane, it can be viewed two-dimensionally very intelligibly on the display screen.

Further, if the 3D model 1 is rotated for three-dimensional view, since the projected figure and the attribute information are placed on the same plane, they are very easily identifiable. For example, a comparison between FIG. 31 and FIG. 32 shows that the presence of the projected FIG. 22 makes the positions that the attribute information refers to more clearly identifiable.

Next, an example method of making the attribute placement planes easily selectable will be explained. A first possible method involves displaying the frames of selectable attribute placement planes of a 3D model and allowing the operator to select a desired attribute placement plane using an input device such as mouse or other pointing devices (FIG. 29).

Another method may involve displaying a list of names of selectable attribute placement planes for the operator to select a desired name (not shown).

Still another method may involve displaying thumbnail icons for images of the attribute placement planes as seen from the direction of sight line (reference numbers 102, 101 and 103 of FIG. 13).

<<Other Methods of Entering Attribute Information>>

In the above explanation about entering attribute information with reference to FIGS. 32 to 35, the attribute information is associated with individual attribute placement planes. The association is not limited to this method. For example, the attribute information may be grouped and then the group may be associated with the attribute placement planes.

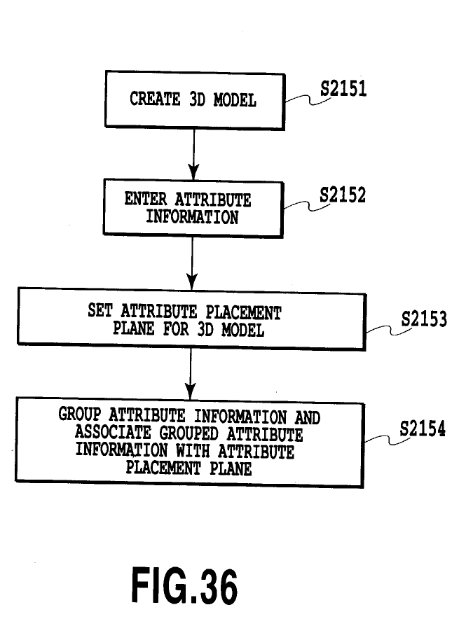

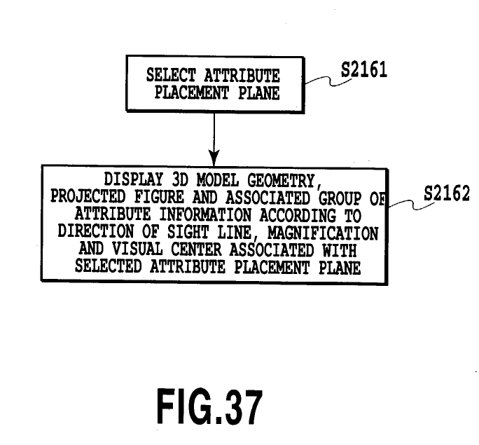

Referring to the flow charts of FIG. 36 and FIG. 37, the other input methods will be described.

The attribute information that was entered in advance is grouped selectively or according to a search result, and the grouped attribute information is associated with a desired attribute placement plane. This produces a result and effect similar to those described above. The attribute information associated with the attribute placement plane can be manipulated by making modifications, such as addition or deletion, to the group of attribute information.

That is, a 3D model 1 is generated (step S2151), attribute information is entered (step S2152), and a position of view point, a direction of sight line and a magnification of the attribute placement plane are set for the 3D model 1 (step S2153). Then, the attribute information entered in step S2152 is grouped, and the grouped attribute information is associated with the attribute placement plane (step S2154).

For display, a desired attribute placement plane is selected as shown in FIG. 37 (step S2161), and then the attribute information associated with the selected attribute placement plane is displayed on the display 204 according to the information on the position of viewpoint, the direction of sight line and the magnification associated with the selected attribute placement plane (step S2162).

<<Setting of Attribute Placement Plane and Projected Figure of Cross Section>>

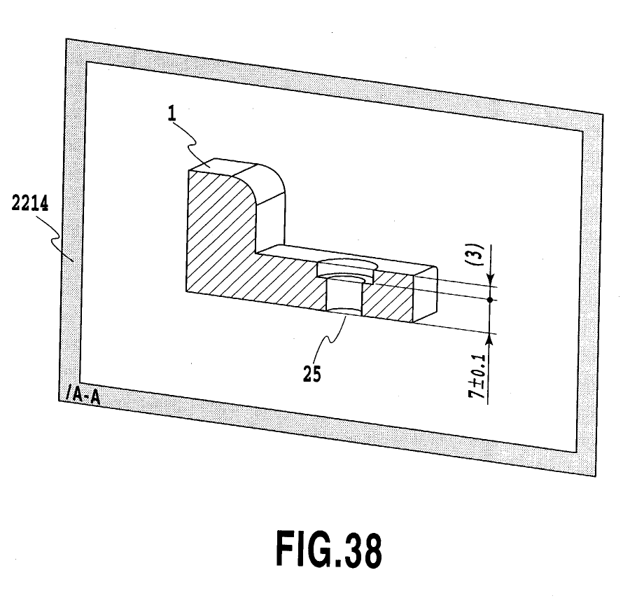

The projected section view 5 will be given more detailed explanation by referring to FIG. 38. A cross-sectional plane is set at a desired position in the 3D model 1 (e.g., the plane may pass through the center of a hole and extend parallel to the front view), and an attribute placement plane 2214 is set by taking a direction normal to the front or back side of the cross-sectional plane as the direction of sight line. For example, the section view of the 3D model 1 can be displayed by undisplaying the front side of the cross-sectional plane with respect to the sight line direction. The projected FIGS. 25 of the cross section and of the shape of a portion beyond the cross-sectional plane are arranged on the attribute placement plane 2214. By entering the attribute information and associating it with the attribute placement plane 2214, it is possible to display the attribute information in such a manner that the operator, when he or she looks at the two- or three-dimensional section view and projected figure, can easily and quickly understand the portions the attribute information refers to. The attribute information may, for example, be dimensions and annotations on a surface that cannot be seen unless shown in cross section, or dimensions whose leader lines cannot be seen unless shown in cross section.

<<Setting of Two or More Projected Figures>>

It is also possible to set a plurality of attribute placement planes on which the shapes of the 3D model 1 look the same, i.e., whose directions of sight lines are the same and to put the same projected figure on each of the attribute placement planes. Similarly, a plurality of attribute placement planes with the same direction of sight line may be set for the same cross section.

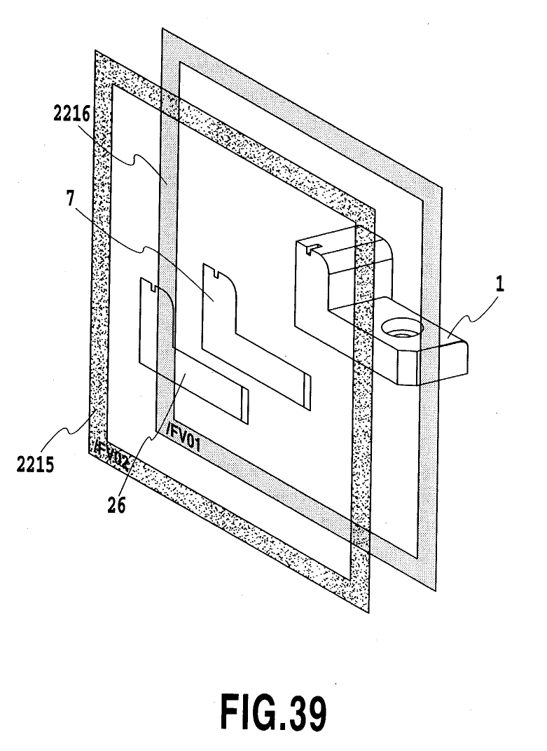

FIG. 39 shows a plurality of attribute placement planes 2215, 2216 with the same direction of sight line and a plurality of projected FIGS. 26, 27 projected in the same direction onto the attribute placement plane 2215, 2216. In FIG. 39 the attribute placement plane 2215 and the attribute placement plane 2216 are planes that correspond to the front views of the 3D model 1. By grouping and associating the attribute information with the attribute placement planes 2215, 2216, the attribute information can be made more readable. For example, the attribute placement plane 2215 may be associated with attribute information concerning a rough external dimension of the 3D model and the attribute placement plane 2216 may be associated with a detailed shape of the 3D model 1 (FIG. 22). In that case, the magnifications of the attribute placement planes 2215, 2216 can be given different settings. For example, the magnification associated with the attribute placement plane 2215 is set to 1 and the magnification associated with the attribute placement plane 2216 is set to 2. This arrangement makes the attribute information concerning the detailed shape easily recognizable.

In setting a plurality of attribute placement planes, it is possible to set the attribute placement planes according to the kind of attribute information with which they are associated, for example, setting one attribute placement plane for attribute information concerning the hole position and hole shape and another attribute placement plane for attribute information concerning secondary processing such as printing and painting.

<<Placement of Attribute Information>>

To display a 3D model and attribute information to be added to the 3D model on a screen in a manner that makes them very easy to read as a two-dimensional drawing, an operator selects or groups together a plurality of pieces of attribute information on that portion of the 3D model that the operator wants displayed, and associates them with an attribute placement plane. In a two-dimensional representation, the attribute information needs only to be arranged on an area perpendicular to the direction of projection of the associated projected figure, i.e., perpendicular to the direction of sight line of the attribute placement plane. In a “3D drawing” which assigns attribute information to a 3D model, however, some improvements are needed to take full advantage of the merits of 3D model.

One of the merits of 3D model is that, since an object can be represented on the screen as a three-dimensional shape closely resembling the real object, an operator generating a 3D model or operators in the subsequent processes using the generated 3D model (process designer, mold designer/manufacturer, persons making measurements, etc.) can eliminate a work of transforming the drawing from two dimensions to three dimensions (this is done mainly in the mind of the operator) which is required in handling two-dimensional drawings. This transforming work depends largely on the ability of individual operators and it is in this transformation process that erroneous conversions leading to wrong fabrication and time loss are likely to occur.

To keep the merit of the 3D drawing that an object can be represented three-dimensionally, some improvements need to be made on the way the attribute information is shown (placement of the attribute information) when a 3D model is three-dimensionally displayed.

The improvements will be explained by referring to FIGS. 23A to 23D.

A first improvement is on a plane on which the attribute information is placed. In Embodiment 2, FIGS. 23A to 23D are similar to those used in connection with Embodiment 1.

First, to create a top view of the 3D model 21, an attribute placement plane (not shown), a projected FIG. 22 and attribute information are entered. The 3D model 21 as seen from the direction of sight line of this attribute placement plane is shown in FIG. 23B.

Regarding the input of the attribute information, if planes on which a plurality of sets of attribute information are placed are staggered as shown in FIG. 23C, the sets of attribute information overlap, making them difficult to read. Even in FIG. 23C, with only a small volume of attribute information, it is not easy to read. If the object has a more complicated shape, it is easily imagined that the attribute information will no longer be useful information and, in a perspective view, will make the drawing unintelligible.

However, by arranging the attribute information on the same plane as the projected FIG. 22, as shown in FIG. 23D , the sets of attribute information can be prevented from overlapping each other, with the result that the attribute information can be recognized as easily as in a two-dimensional drawing representation (FIG. 23B).

Thus, a drawing that adds attribute information to the 3D model 21 (three-dimensional drawing) can not only be used as a two-dimensional drawing but also as a three-dimensional drawing because this arrangement offers the 3D model merit of being able to present the attribute information in an easily recognizable manner even during a three-dimensional representation of the 3D model 21.

What has been explained above also applies to the case where attribute information is associated with a plurality of attribute placement planes that are created in the same direction of sight-line.

Further, when a plurality of attribute placement planes are created in the same direction of sight line, it is preferred that they be put apart from each other (FIG. 39). When a plurality of attribute placement planes, the projected figures projected onto the attribute placement planes and the attribute information associated with them are to be displayed simultaneously, if the attribute placement planes are created at the same position, the attribute placement planes lie on the same plane. As a result, the attribute information overlap when seen not only in the direction of sight line but also in a diagonal direction deviated from the line of sight, making them undistinguishable. The primary reason for putting attribute information on a plurality of attribute placement planes is that the volume of attribute information is too large to put in a single attribute placement plane when seen from one direction. It is therefore unavoidable that the attribute information becomes overcrowded when multiple sets of attribute information are displayed simultaneously.

Although it cannot be helped that the attribute information is crowded when seen from the direction of sight line, it is effective to arrange the projected figures, that were created in the same direction of sight line, apart from each other in making the attribute information more recognizable when seen at an angle.

A second improvement is on the method of extracting attribute information.

To extract the attribute information from the 3D model onto a attribute placement plane in a three-dimensional space on which a projected figure is placed, leader lines or extension lines need to be bent and extended, like L-shaped lines. There are two possible methods of extraction. One is to bend the lines on the 3D model 1 side as shown in FIG. 24 (by extracting the attribute information from the 3D model 1 and then, at the dimension line position, moving it onto the attribute placement plane (not shown) on which projected FIG. 2 is generated; this is represented by lines 11). The other is to bend the lines on the attribute placement plane (by connecting the 3D model 1 and the projected FIG. 2 on the attribute placement plane with lines and then extracting the attribute information on the attribute placement plane; this is represented by lines 12). In this invention, to make more effective use of the attribute information and the projected figures, the method of bending the lines on the attribute placement plane is preferred. This method makes clearly recognizable which portion in the projected figure the attribute information refers to. This method therefore can take full advantage of the merit of the 3D model.

<<Magnification>>

Next, a magnification of an attribute placement plane will be explained. The magnification refers to a factor by which a 3D model geometry, a projected figure and attribute information in a (virtual) three-dimensional space is shown magnified or contracted on the display 204. By setting the magnification to an appropriate value, it is possible to make a complex shape or detailed shape more easily recognizable. Further, a large shape can be reduced in size for better understanding of an overall geometry of the object.

FIGS. 25A to 25C are partly enlarged views of a 3D model 31. For example, as shown in FIG. 25A, an attribute placement plane is set by directing the sight line toward a top view of the 3D model 31, setting the visual center near a corner of an object, and setting the magnification to five times (5×). This setting enables a stepped geometry and its attribute information to be displayed very intelligibly (FIG. 25B).

This Embodiment 2 is applicable to general 3D-CAD irrespective of hardware making up the 3D-CAD equipment or the method of building the 3D geometric model.

Further, the size of the attribute information (height of letters and symbols) associated with the attribute placement plane (not shown) is changed according to the magnification of the attribute placement plane (FIG. 25B).

The size of the attribute information (e.g., in mm) is defined to be a size it has in a virtual three-dimensional space in which the 3D model 31 exists (not the size when displayed on the display 204).

Suppose, for example, the attribute information has a size of 3 mm in the attribute placement plane when the magnification is 1×. An example of displaying the attribute placement plane with a magnification ×5 and with a letter height of 3 mm is shown in FIG. 25C. Since the attribute information associated with the attribute placement plane is displayed with a magnification ×5, its size is 15 mm. The increased size may be good for seeing but the 15-mm size is more than necessary. When there is other information that the operator wants to see at the same time, such a large size is not preferable.

In FIGS. 25B and 25C, a rectangular line represents a displayable range of the display 204.

If the attribute information is arranged not to overlap, the attribute information position is located away from the 3D model and projected figure, so that the association between the geometry and the attribute information becomes unintelligible, leading to possible misreading. Further, when a large volume of attribute information is to be displayed, all the information may not be able to be displayed on the display 204 and, in that case, the operator must change a display range to view the attribute information outside the current displayable range.

When the attribute information is to be displayed in a reduced size (magnification is less than 1×) and if the letter size is not changed, the attribute information becomes unintelligible because a displayed size of the attribute information on the display 204 decreases in a reduction display mode.

It is therefore desirable to change the size of attribute information according to the magnification, considering the conditions in which the attribute information is displayed.

Hence, it is appropriate to set the magnification and the size of attribute information almost inversely proportional to each other. Take for example a case in which the size of attribute information is set to 3 mm when the magnification of the attribute placement plane is 1×. If the magnification of the attribute placement plane 32 is 5×, the size of the associated attribute information is set to 0.6 mm.

If the attribute information already associated with an arbitrary attribute placement plane is now associated with another attribute placement plane, the size of the attribute information is changed according to the magnification of the destination attribute placement plane.

<<Selection of Multiple Projected Figures>>

In the above Embodiment 1, when the attribute information associated with an attribute placement plane is to be displayed, the number of attribute placement planes selected has been described to be only one. In view of the object of this invention, there is no problem if two or more attribute placement planes are selected.

It should be noted, however, that although the selection of a single attribute placement plane produces only one each of direction of sight line, magnification and visual center and thus specifies only one display method, the selection of a plurality of attribute placement planes results in two or more display methods. The latter case therefore requires some additional means of control. For example, when a plurality of attribute placement planes are selected, it is possible to display all the attribute information associated with the selected attribute placement planes to allow an operator to choose a desired setting for the direction of sight line, the magnification and the visual center.

Further, an improvement is made as by changing a color of the attribute information for each attribute placement plane to make the groups of attribute information easily distinguishable.

<<Method of Displaying Attribute Information>>

In selectively displaying attribute information assigned to a 3D model, a conventional method has been described to consist in selecting an attribute placement plane and then displaying the attribute information associated with the attribute placement plane as needed. The method for selective display of attribute information is not limited to this sequence of operations. For example, another possible method may involve selecting attribute information and then displaying the 3D model, the projected figure and the attribute information according to a direction of sight line, a magnification and a visual center of the attribute placement plane to which the attribute information is related.

FIG. 26 is a flow chart showing the sequence of operations described above.

With the 3D model 1 and the attribute information displayed as shown in FIG. 31 (attribute information associated with other attribute placement planes may also be displayed at the same time), attribute information (for example, 35±0.3) is selected (step S311).

This selection causes the 3D model 1, the projected figure and the attribute information to be displayed according to the direction of sight line, the magnification and the visual center of the attribute placement plane to which the attribute information is related (step S312). In this case, a front view indicated at 102 in FIG. 13B is displayed.

As a result, the relation between the selected attribute information and the 3D model 1 is shown two-dimensionally, contributing to an improved ease of recognition.

Another effective method may also involve selecting geometry information on the 3D model (edge, face and vertex), displaying the attribute information associated with the geometry information, and also displaying the 3D model, the projected figure and the attribute information according to the direction of sight line, the magnification and the visual center of the attribute placement plane associated with the attribute information.

FIG. 27 is a flow chart showing this sequence of operations (from the selecting of attribute information to the displaying).

Geometry information on a 3D model is selected (S321).

Attribute information associated with the selected geometry information is displayed (step S322).

If there are a plurality of pieces of associated attribute information, all of them may be displayed. It is also possible to display all attribute information belonging to the attribute placement planes associated with the attribute information.

Next, according to the direction of sight line, the magnification and the visual center of an attribute placement plane associated with the displayed attribute information, the 3D model, the projected figure and the attribute information are displayed (step S323).

As described above, since a search for related attribute information can be made from geometry information on a 3D model and the searched attribute information can be displayed, this system is very easy to use.

<<Displaying>>

Here, an explanation will be given as to how the 3D model assigned with the attribute information generated as described above is displayed. In Embodiment 2, explanations on the display procedure referring to FIG. 5 and FIG. 13 are similar to those given in <<Displaying>> in the Embodiment 1.

<<Inputting of Inspection Specifications>>

Next, how inspections are specified will be explained.

To inspect a finished mold and part, a 3D model is assigned with dimensions and other information before being displayed, as described above.

Here, attribute information is entered into a set attribute placement plane in such a manner as will make clear what portions should be inspected.

That is, for the surfaces, curves and edges making up the 3D model, the order of inspection, the positions to be inspected and the items to be inspected are input. By performing inspections according to the specified order, the number of inspection steps can be reduced.

First, items and positions to be inspected are entered to be associated with the entire 3D model to be entered. This is followed by determining the order of inspections according to a predetermined method to allocate specific sequence numbers to individual items. In performing the actual inspection, specifying a sequence number causes the associated attribute placement plane to be selected for display-and the surfaces of the 3D model to be inspected are displayed in a form (e.g., color) different from other surfaces, clearly indicating the inspection positions.

Then, for each inspection item specified, a result of inspection is entered to decide whether remolding is needed or not.

According to the Embodiment 2 of this invention, as described above, it is possible to obtain an easy-to-see displayed view with a simple manipulation. Further, with the displayed view an operator can understand the relation between the direction of sight line and the attribute information at a glance. Further, since dimension values are entered in advance, misreading of these values due to erroneous operations on the part of the operator can be reduced.

Further, since only the information associated with the attribute placement plane can be displayed, the necessary information can be found easily.

A large volume of attribute information associated with the same direction of sight line can be assigned to a plurality of attribute placement planes so that data can be made easily recognizable and necessary information found quickly.

Further, by setting an attribute placement plane in an interior of the 3D model, i.e., on a cross section, the attribute information can be displayed intelligibly.

Further, since the size of the attribute information is changed according to the display magnification of an attribute placement plane, the attribute information can be displayed appropriately for easy reading.

Further, by placing the attribute information and the projected figure on an attribute placement plane, the attribute information can be read even if the 3D model is viewed at an angle.

Further, by generating a 2D figure or text information on an attribute placement plane, a more intelligible representation and display can be made.

From the attribute information, it is possible to search for a desired attribute placement plane and see only the information associated with that attribute placement plane. This enables an operator to know the necessary information easily and quickly.

Furthermore, from geometry information, it is possible to search for desired attribute information and attribute placement plane and also to view only the information associated with that attribute placement plane. The operator can therefore obtain the necessary information easily and quickly.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. An information processing apparatus comprising:
a projection unit for projecting a 3D (three-dimensional) model in an arbitrary plane in the same 3D space in which the 3D model is placed; and
a storing unit adapted to store attribute information for the 3D model in a memory, the attribute information associated with the projection plane;
wherein said projection unit places the attribute information on the projection plane of the 3D model.

2. An information processing apparatus according to claim 1, further comprising an input unit for inputting attribute information for the 3D model.

3. An information processing apparatus according to claim 1, wherein said projection unit projects the 3D model in the selected direction of sight line.

4. An information processing apparatus according to claim 3, wherein said storing unit stores the direction of sight line and the attribute information with associating them each other in the memory.

5. An information processing apparatus according to claim 1, wherein said projection unit displays the front of the projection plane of the 3D model selectively.

6. An information processing method comprising:
a projection step of projecting a 3D model in an arbitrary plane of a 3D space;
an attribute placement step of placing the attribute information for the 3D model, associated with the projection plane, on the projection plane of the 3D model.

7. An information processing method according to claim 6, further comprising an input step of inputting the attribute information.

8. An information processing method according to claim 6, wherein the projection step projects the 3D model in the selected direction of sight line.

9. An information processing method according to claim 8, wherein the direction of sight line and the attribute information is stored in the memory with associating them each other.

10. An information processing method according to claim 9, further comprising a display step of displaying the front of the projection plane of the 3D model.

11. A computer program product for executing an information processing method comprising:
a projection step of projecting a 3D model in an arbitrary plane of a 3D space; and
an attribute placement step of placing the attribute information for the 3D model, associated with the projection plane, on the projection plane of the 3D model.

12. A computer program product for executing an information processing method according to claim 11, wherein the information processing method further comprises an input step of inputting the attribute information.

13. A computer program product for executing an information processing method according to claim 11, wherein the projection step projects the 3D model in the selected direction of sight line.

14. A computer program product for executing an information processing method according to claim 13, wherein the direction of sight line and the attribute information is stored in the memory with associating them each other.

15. A computer program product for executing an information processing method according to claim 11, wherein the information processing method further comprises a display step of displaying the front of the projection plane of the 3D model.
